(19) United States
(12) Patent Application Publication
(10) Pub. No.: US 2023/0360902 A1
(43) Pub. Date: Nov. 9, 2023

(54) PHOTOREACTOR AND SOURCE FOR GENERATING UV AND VUV

(71) Applicant: United Kingdom Research and Innovation, Swindon Wiltshire (GB)

(72) Inventors: Alex Robinson, Oxfordshire (GB); Matthew Gear, Oxfordshire (GB)

(73) Assignee: United Kingdom Research and Innovation, Swindon Wiltshire (GB)

(21) Appl. No.: 18/028,996

(22) PCT Filed: Oct. 20, 2021
(86) PCT No.: PCT/EP2021/079112

§ 371 Date: Mar. 28, 2023

(30) Foreign Application Priority Data
Oct. 21, 2020 (GB) 2016684.9

(51) Int. Cl. H01J 65/04; H01J 61/10; H01J 61/06; H01J 61/02; H01J 61/16; B01D 53/00; B01D 53/50; B01D 53/56; B01D 53/60; B01D 53/44; C02F 1/32

(52) U.S. Cl. CPC H01J 65/044; H01J 61/10; H01J 61/06; H01J 61/025; H01J 61/16; B01D 53/007; B01D 53/50; B01D 53/56; B01D 53/60; B01D 53/44; C02F 1/325; B01D 2258/02; B01D 2259/804; B01D 2259/806; B01D 2257/302; B01D 2257/404; B01D 2257/708; C02F 2201/3221; C02F 2201/326; C02F 2101/30

(57) ABSTRACT

There is provided a photoreactor for the remediation of gaseous emissions and/or contaminated water using ultraviolet (UV) or vacuum ultraviolet (VUV). There is also provided an emission source for generating UV and/or VUV, the source comprising: a microwave generator; a chamber arranged to receive microwaves generated by the microwave generator, the chamber comprising: a gas comprising species for forming excimers; a resonator arranged to receive the microwaves in the chamber and generate a plasma; a first electrode spaced apart from the resonator; and a voltage source configured to generate an electric field between the resonator and the first electrode, wherein, on application of the electric field, the electric field drives electrons and/or ions from the plasma to generate excimers and produce vacuum ultraviolet or ultraviolet emission. There are also provided methods of generating UV and/or VUV, and methods of remediating fluids.

### TECHNICAL FIELD

The present invention relates to a photoreactor for the remediation of gaseous emissions and/or contaminated water using ultraviolet (UV) or vacuum ultraviolet (VUV).

The present invention further relates to a source for generating UV and/or VUV.

### BACKGROUND

Studies have indicated that ultraviolet radiation can be used for treatment of water containing a wide range of organic substances. The ultraviolet radiation used is UV-A (400-315 nm) and UV-B (315-280 nm). The use of UV has been investigated for treatment of wastewater containing dyes from clothing, domestic greywater, industrial wastewater and other water containing dissolved organic matter. Much of the research on the use of UV and VUV on wastewater has been performed using low-pressure mercury lamps which emit either UV-C at 254 nm or emit a combination of UV-C at 254 nm and 184 nm. In the latter case such lamps produce mostly 254 nm radiation but investigations have been based on the wastewater receiving both, and a resulting mix of electronic transitions being induced.

VUV water treatment belongs to a category of water treatment techniques known as Advanced Oxidation processes (AOP). AOP are water treatment processes that rely on in-situ generation of reactive hydroxide radicals (HO·). AOP may include ozonation (generation of ozone and mixing it with water), use of hydrogen peroxide or a combination such as ozone with UV-C. AOP techniques may or may not use UV or VUV or they may involve combinations with catalysts such as titanium dioxide, or Fentons reagent and hydrogen peroxide. The use of excimer lamps has also been studied. Excimer lamps based on xenon produce VUV at 172 nm which is close to the peak absorption for water and therefore results in greater quantum yields of the hydroxide radical HO· than the shorter wavelength of 184 nm produced by low pressure mercury lamps.

In addition to the use of VUV and UV for the treatment of water, the use of VUV and UV for the remediation of gaseous emissions has been studied and is in use commercially in some settings. Volatile organic compound (VOC) treatment of air has been commercialised using low-pressure mercury lamps and photocatalysts. SOx and NOx remediation of air using UV has also been contemplated. However, NOx is more easily removed from air by conventional water/alkali scrubber technology, and wet scrubbers are commonly used to remove SO₂.

Much of the focus on treatment of air and wastewater using ultraviolet has focused on longer wavelengths. Hence, it is desirable to investigate the use of the more energetic vacuum ultraviolet (VUV) region which is found at 200-10 nm. This more energetic radiation is expected to be effective at breaking down VOCs, SOx and NOx. The VUV techniques may also provide more effective treatment for any of the wastewater, liquids or gases, currently treated by UV.

A problem with moving to VUV for such treatments is the lack of high intensity sources, and particularly continuous emission (not pulsed) high intensity sources. As mentioned above, conventional low-pressure mercury lamps are able to provide low levels of VUV. There are also other sources available for providing VUV. We discuss below example sources.

### Low Pressure Mercury Lamps

Low-pressure mercury lamps are gas discharge lamps. The lamps may comprise a glass tube with electrodes at either end. A voltage is applied between the two electrodes to generate an arc discharge. The voltage applied across the electrodes maintains the discharge and drives current through the resulting plasma, that is, the ionization is maintained thermally. The gas is low pressure so that ionization occurs easily. The plasma spans the electrodes. The level of ionization is low but it is generally described as a plasma because the level of ionization is not negligible. In other words, the level of ionization is sufficient to change the properties of the gas. Operation usually requires an initial high voltage applied across the electrodes to ionize the gas. Once ionized, a low current maintains ionization. The electrons are driven from cathode to anode by the voltage and in doing so they collide with the discharge gas atoms exciting them. The decay of the gas atoms from the excited states emits light, which for mercury atoms includes light in the UV and VUV.

### Excimer Lamps

Another source of VUV are excimer lamps based on xenon. These may also be low pressure gas discharge lamps and generally consist of a glass tube but, different to the mercury lamps previously discussed, may have the electrodes extending in parallel through or along the sides of the tube so as to provide a smaller gap between the electrodes. Again, electrons are driven from one electrode to the other, colliding with excimer atoms on the way. There needs to be a continuous input of energy to energise the electrons and sustain the discharge. This may be by driving a current through the gas or by application of RF. In either case this is essentially to maintain a thermal plasma. The excimer atoms form excited dimers and decay emitting UV or VUV.

Excimer lamps may alternatively be dielectric barrier discharge (DBD) instead of the arc-type discharge lamp discussed in the preceding paragraphs. In DBD there is an insulating dielectric barrier between the electrodes but are otherwise similar to arc-type discharge lamp. Similar to arc-type discharge lamps the plasma or ionization is spread in the region between the electrodes or between the dielectric barrier and one of the electrodes.

### Microwave Plasmas

A further source of VUV and UV are microwave plasma sources. These consist of a tube comprising a relevant gas, such as xenon, and the tube is arranged passing through a resonant microwave cavity. When microwaves are applied they induce a plasma in the gas in the tube. The plasma extends out from the cavity along the tube, based on a surface wave of the plasma. No DC voltage is applied. Energy is supplied to the plasma by heating from the microwave radiation. The heating energises the electrons to drive the emission process. Microwave plasma sources may operate at a range of pressures but, based on Paschen's law, lower pressure devices are more likely to result in ionisation occurring more easily.

### Corona Discharge-Based Source

A paper by Salvermoser and Murnick, “Efficient, stable, corona discharge 172 nm xenon excimer light source”, Journal of Applied Physics, 94(6), pp 3722-3731, describes a corona-discharge based VUV lamp. A corona discharge is a field-driven discharge where, due to geometry, the region of ionization is limited to a small ionization region. This is the phenomenon sometimes seen around high voltage electric power lines in power transmission systems. A concentration of the electric field because of the geometry causes the discharge. However, the field is not sufficient to cause electrical breakdown of the surrounding gas. The paper by Salvermoser and Murnick describes a lamp comprising multiple needles spaced apart from an aluminium disk cathode, which is held at negative high voltage relative to the needles. Each needle produces a corona discharge at the tip. The gas is xenon at a pressure of 2 bar. The lamp includes UV sensitive glass such that any UV produced results in a green fluorescence. An output power of 35 mW/cm² of VUV was achieved at the centre of the lamp.

As well as processing of wastewater and gaseous emissions, VUV and UV can be used for treating materials such as curing, for surface modification, and producing ozone.

While a number of VUV sources exist in the prior art, a problem exists that prior art devices cannot be scaled easily. For example, for efficient treatment of waste water or gaseous emissions it is desirable to have higher power such as 100's of W or kW.

### SUMMARY OF THE INVENTION

The present invention provides methods of treating wastewater and/or gaseous emission using VUV and/or UV. The present invention further provides a VUV and/or UV emission source or lamp.

The VUV and UV emission source or lamp comprises: a microwave generator; a chamber arranged to receive microwaves generated by the microwave generator; and a voltage source. The chamber comprises a gas having species for generating excimers. The chamber may comprise a resonator arranged to receive the microwaves in the chamber and generate or ignite a plasma at the resonator. The chamber comprises a first electrode, such as an anode, spaced apart from the resonator. The voltage source is configured to generate an electric field between the resonator and the first electrode. The voltage source may be a voltage source that provides DC or steady-state voltage, and thereby generates a DC or steady-state electric field. The voltage source may be electrically connected between the first electrode and the resonator, or between the first electrode and a second electrode which is in contact with, or forms part of, the resonator. The first electrode may be an anode and the second electrode or resonator may be a cathode. The electric field drives electrons or ions from the plasma to generate excimers in the gas and produce vacuum ultraviolet or ultraviolet emission. The electric field drives the electrons and/or ions such as towards the first electrode and (before reaching the first electrode) to collide with the gas species to generate the excimers. The excimers decay to produce the VUV and/or UV emission.

VUV wavelengths are wavelengths in the range 10-200 nm. Preferably, the emission is predominantly in the range 150-200 nm. The emission source or lamp may alternatively configured to produce wavelengths other than VUV or UV, such as wavelengths in the visible part of the spectrum. The gas may comprise species other than those for forming excimers. However, preferably xenon is used to form excimers and generate emission in the VUV and/or UV part of the electromagnetic spectrum. Alternatively, argon, krypton, helium, any noble gas, or mixtures thereof may be used. Other excimers such as XeCl may be used. By use of the term excimers we include not only excited dimers but also excited complexes also known as exciplexes.

The microwave source is provided to generate the plasma separately from the voltage source and electric field, and plasma generation does not require special geometry to enhance the local electric field as in the case of corona discharges. The electric field provided by the voltage source is not used in generating the plasma. The result is that the size and location of the plasma can be controlled independently of the electric field and the geometry providing the electric field. This independence means that the area over which electrons or ions flow from the plasma is increased allowing more power to be applied to the electrons and ions resulting in a higher intensity VUV source or lamp.

The microwave source may be configured with a waveguide to provide the microwaves through the waveguide to the resonator. A waveguide is able to carry a higher power than a coaxial cable.

The resonator is provided to reduce the power of microwaves required to generate the plasma. It is possible to produce an emission source without a resonator but the use of a resonator is preferred since it allows use of lower cost and more widely available microwave sources such as those conventionally used in microwave ovens.

The resonator receives microwaves and generates the plasma, that is, a region of ionization in the gas. The plasma is a thermal plasma which is localised at the resonator. The region of the plasma is similar to the ionization region when a corona discharge occurs such as around a needle. However, in a corona discharge the plasma is generated by the electric field whereas in the present embodiment it is a thermal plasma generated by the microwaves and resonator. In comparison to a low pressure discharge lamp the electron density, or charged particle density, will be higher for the presently described device, not only in the region of the plasma but also in the drift region. The plasma may have a size of the order of millimetres and/or tens of millimetres, such as less than 10 mm, for example 2 to 10 mm, or may be 2 to 20 or 2 to 50 mm.

The voltage source, which is preferably a voltage source generating DC voltage, may be a high voltage or HV source and may be connected across an anode and cathode. The resonator or region of the plasma may be a localised region between the anode and cathode. Preferably, the resonator is located at, or close to, one of the anode and cathode, such as being in contact with one of the anode and cathode.

In test configurations, the gas may be supplied to the chamber just prior to generation of the plasma. The gas pressure may be in the range from slightly above atmospheric pressure down to sub-atmospheric. In one embodiment the gas pressure is around half an atmosphere, but could be between 0.1 and 1.0 atm. In other embodiments, the gas pressure may be slightly more than one atmosphere such as 10-20% or up to 50% higher than atmosphere. In product configurations the gas is maintained contained in the chamber.

The resonator is preferably configured to generate the plasma at the resonator independently of the electric field. The resonator may be configured to generate the plasma at an electron or ion source region at the resonator, and the electric field drives the ions or electrons towards the first electrode through a drift region.

The first electrode may be an anode.

At least part of the resonator may extend into or across the straight-line path between the resonator and first electrode so as to spread the area across which the electrons or ions are driven towards the first electrode. This spreading of the area increases the power that can be coupled to the electrons and ions and hence results in an increase in VUV and/or UV emission intensity. The width or size of at least a part of the resonator transversely to a straight-line path from, for example, the centre of the plasma to the first electrode is larger than width of the plasma. Increasing the area of the resonator may increase the power output in VUV and/or UV emission. In some embodiments, it may be possible to provide a mesh or crown close to the resonator to obscure the path of electrons and/or ions so as to increase the area across which current can flow and thereby increase the VUV/UV output.

The chamber may comprise a waveguide with a short-circuit termination. The resonator may comprise an initiation region where the plasma initiates. The resonator may be disposed with the initiation region at a position substantially an odd number of quarter-wavelengths from the termination of the waveguide. Where the chamber is formed as a waveguide, the wavelength used for specifying the odd-number of quarter wavelengths is the wavelength of the microwaves in the waveguide, which may for example be a longitudinal wavelength and will be different to the wavelength of the microwaves in free space due to dispersion/interference effects. Alternatively, if the resonator has a free-space configuration then the wavelength in free-space should be used in the specification. In a preferred embodiment which uses a waveguide-based chamber, microwaves having a frequency of 2.45 GHz (corresponding to a free-space wavelength of around 12.2 cm), in a waveguide will have a wavelength of around 17.85 cm. These frequencies and wavelengths are example values and others may be used. In a preferred embodiment, the odd-number of quarter-wavelengths may be five.

The resonator may comprise a planar structure configured to provide a planar region of electron injection to the gas. The resonator may comprise an opening or mouth for receiving microwaves from the microwave generator, the mouth or opening extending into a slot or channel with an end termination. The end termination may form a back wall of the resonator. The resonator may comprise an upper and lower jaw, each jaw having a planar region. The back wall may form a back of the mouth of the jaws. At least one of the jaws may have holes therethrough, for example, the jaw closest to the first electrode.

The slot or channel may have a length substantially equal to a quarter of the wavelength of the microwaves. The length may be the distance from the opening or edge of the mouth to the end termination. Alternatively, the slot or channel may have a length substantially equal to an odd number of quarter wavelengths of the microwaves.

The resonator jaws may each be formed by a plate or plate regions such as upper and lower plates or plate regions. The jaws themselves may be formed form a flat sheet or plate that is bent into a U or C-shaped. Alternatively, the jaws may be made from one or more pieces of bulk material machined to a U or C-shape to form the jaws.

The planar regions of the resonator jaws may be parallel and spaced apart, the planar regions may be parallel to the plane of the anode and/or a planar cathode, and, for example, form an open quarter-wave resonator. One of the plates or planar regions may comprise a pin extending into the slot or channel from one of the plates or plate regions.

Alternatively, the plates of the resonator jaws may be co-planar and arranged transverse to the plane of the anode and/or a planar cathode, for example as slot resonator.

The resonator may be U-shaped or C-shaped, or may be cup-like with open or perforated sides.

The resonator may comprise multiple slots, such as with the slots stacked such as vertically stacked one above the other.

The chamber may comprise multiple resonators.

The emission source may further comprise a waveguide configured to guide the microwaves from the microwave generator to the chamber.

The chamber may comprise one or more gas ports for fill and/or evacuation of the gas.

The chamber may comprise metal walls with a microwave window for receiving the microwaves and an optical window for exit of generated VUV and/or UV. The chamber may be formed of plates bolted together or, more preferably, multiple walls may be formed monolithically such as from a solid metal block.

The emission source may further comprise a microwave barrier to block or reduce exit of microwaves from the chamber but allowing VUV and/or UV to pass there through. The microwave barrier may be arranged across the optical window.

The first electrode may be an anode and the chamber may further comprise a cathode.

The resonator or resonators may be arranged in contact with one of the anode or cathode, the voltage source generating an electric field between the anode and the cathode.

The resonator or resonators may be arranged between the anode and cathode, and the resonator or resonators may be in contact with a face of one of the anode or cathode and may face the other of the anode or cathode.

The anode and cathode may each comprise a planar surface, the planar surfaces may be spaced apart and substantially parallel.

The anode and cathode may comprise plates spaced apart from walls of the chamber.

At least one of the anode and cathode may be electrically isolated or insulated from walls of the chamber.

The first electrode or a second electrode may be connected to a conductor extending from the chamber and for connection to the voltage source. The emission source may further comprise a microwave reflector disposed axially to the conductor for reflecting microwaves back to the chamber. The microwave reflector may comprise an enclosed bowl shape cavity facing towards the chamber. The bowl shape cavity may be a hemisphere. The conductor may extend through the origin of the hemisphere. The conductor may be connected to a feedthrough for connection to the voltage supply. The microwave reflector may also be useful in apparatus other than the chamber described herein where it is desirable to prevent microwave radiation from being transferred from a chamber or enclosure along a conductor.

The VUV or UV light may be generated at 172 nm. The gas comprising species for generating excimers may be xenon gas.

The emission source may further comprise a controller arranged to: control the microwave source to generate a first power level of microwaves to initiate the plasma; control the microwaves source or an attenuator to reduce the power level of microwaves incident in the chamber to a second level, lower than the first, to sustain the plasma; and control the voltage source to turn on or increase the voltage so as to increase the electric field between the resonator or resonators and first electrode to drive the electrons or ions from the plasma to generate the excimers in the gas and produce the vacuum ultraviolet or ultraviolet emission.

The microwave source may be a magnetron. The microwave source may be configured to provide microwaves at a frequency in air of 2.45 GHz. The microwave source may be configured to provide a maximum power of 2 kW, or may be configured to provide 1 kW or less, such as microwave power in the range 300-900 W.

The voltage source may be an HV source configured to supply a voltage between the resonator and first electrode, or between the first electrode and a second electrode, of the order of kV or tens of kV, for example between 1 and 25 KV or higher.

There is provided a method of generating vacuum ultraviolet (VUV) or ultraviolet (UV) emission, comprising: providing in a chamber a gas comprising species for generating excimers; supplying microwaves at a first power level to a chamber comprising a resonator or resonators to generate a plasma at the resonator; reducing or attenuating the power level of the microwaves supplied to the chamber to a second level, lower than the first level, to sustain the plasma; supplying a high voltage to generate an electric field in the chamber to drive electrons or ions from the plasma to generate excimers in the gas so as to produce the VUV or UV emission. The high voltage may be provided between the resonator or resonators and a first electrode in the chamber.

There is further provided a photoreactor for receiving fluid for treatment, the photoreactor comprising: a VUV or UV emission source or lamp such as set out above; and a vessel or tube for receiving the fluid for treatment, the vessel or tube having one or more regions transparent to VUV and/or UV for receiving VUV or UV from the emission source or lamp. The photoreactor may further comprise a second chamber in which is disposed the vessel or tube. The photoreactor may further comprise a microwave barrier arranged between the chamber of the VUV or UV emission source and the second chamber to block or reduce microwaves from the VUV or UV emission source from entering the second chamber. The vessel or tube for receiving the fluid may be a tube, and the second chamber may be a metal walled box with holes through which each end of the tube extends.

There is further provided a recycle photoreactor system, comprising the photoreactor set out above, and further comprising: a flow circuit around which the fluid for treatment may flow into and out of the vessel or tube; and a pump for circulating the fluid around the flow circuit and through the vessel or tube. The vessel or tube may be substantially tubular. If the fluid for treatment is liquid, the vessel or tube may be arranged such that the flow direction of the liquid is through the tube in a direction substantially vertically upwards.

The present invention further provides a method of treating a fluid, comprising: flowing the fluid for treatment through a vessel or tube connected in a flow circuit; generating VUV or UV emission using the a VUV or UV source or lamp such as those described herein or the methods described herein; directing the VUV or UV at the fluid flowing in the vessel or tube; circulating the fluid through the vessel or tube and flow circuit; and removing the treated fluid. The fluid may be a gas such as gaseous emissions or may be a liquid such as water containing waste or contaminants. If a gas is being treated, the process may remediate NOx, SOx and/or VOCs. If the fluid is contaminated water, the process may remediates organic compounds in the water.

In alternative embodiments the present invention may provide a lamp, comprising: a chamber comprising a gas; an electron or ion generator, which may also be described as a charged particle generator, for generating electrons or ions to produce a plasma in the gas; a voltage source connected across electrodes in the chamber for accelerating the electrons and/or ions through the gas, resulting in collisions between gas species and the electrons and/or ions causing emission of radiation, wherein the plasma is created independently of the voltage source. The gas atoms may be excimer forming gas atoms such as xenon, krypton or argon, and the emission from the lamp may be in the VUV and/or UV. Preferably, a resonator is provided in the chamber to reduce microwave power required to ignite the plasma.

As well as processing of wastewater and gaseous emissions, the VUV and UV sources described herein may be used for treating materials such as curing, for surface modification, and producing ozone.

### BRIEF DESCRIPTION OF THE DRAWINGS

Embodiments of the present invention, along with aspects of the prior art, will now be described with reference to the accompanying drawings, of which:

FIG. 1 is a schematic diagram of a photoreactor according to the present invention;

FIGS. 2a and 2b are diagrams of arrangements for generating corona-discharge according to the prior art;

FIGS. 3a, 3b and 3c are respectively: FIG. 3a is a graph of increasing power that can be disposed into a discharge between parallel plates for increasing voltage applied across them, FIGS. 3b and 3c are arrangements for generating ions or a plasma and driving the ions over a wide area;

FIGS. 4a-4c are schematic diagrams showing steps in the operation of plasma chamber for generating VUV or UV emission according to an embodiment of the present invention;

FIG. 5 is schematic block diagram showing elements and control of a UV/UV emission source according to the present invention;

FIG. 6 is a block diagram showing details of the microwave components supplying the microwaves to the chamber;

FIG. 7 is perspective drawing of the plasma chamber;

FIGS. 8a-8k are embodiments of the resonator, multi-slot resonators and multi-resonators, according to the present invention;

FIG. 9 is a photograph showing the plasma arc produced by the resonator of embodiment of FIG. 8b;

FIG. 10 is a photograph showing the plasma arc produced by the resonator of embodiment of FIG. 8c;

FIG. 11a is a perspective drawing of a plasma chamber with photoreactor coupled thereto;

FIGS. 11b and 11c shows cross-sectional diagrams through the plasma chamber in two orthogonal directions;

FIG. 12 shows a perspective drawing and plan diagrams of the microwave barrier;

FIG. 13a is a cross-sectional diagram of a microwave reflector element on the HV DC supply feed;

FIGS. 13b and 13c are plots of simulations of electric field strength in the microwave reflector element of FIG. 13a;

FIG. 14 is a process flow diagram of the core process of the recycle photoreactor system comprising chamber and photoreactor;

FIG. 15 is a process flow diagram, including ancillary components of the core process of the recycle photoreactor system comprising chamber and photoreactor;

FIG. 16 is a flow chart setting out steps of a method of operating the microwave source and HV source;

FIG. 17 is a flow chart setting out the steps of a method of operating the recycle flow reactor; and

FIGS. 18a and 18b are respectively a schematic diagram of a continuous flow photoreactor system and a flow chart setting out the steps of a method of operating the continuous flow photoreactor system.

### DETAILED DESCRIPTION

The embodiments described herein relate to photoreactor systems for treating wastewater and gaseous emissions. Further embodiments relate to VUV and UV sources for the photoreactor systems, although it will be appreciated that the photoreactor systems may use other sources than those described here, and the VUV and UV sources may be applied to uses other than the processes described herein. We start by discussing a photoreactor system.

### Photoreactor

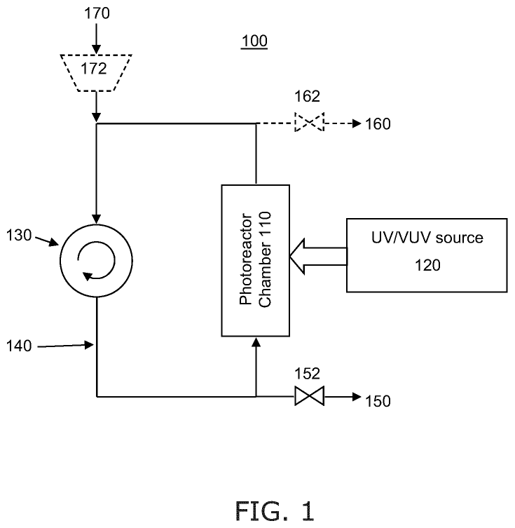

FIG. 1 is a schematic diagram of a photoreactor system 100 according to the present invention. The system of FIG. 1 is based on batch processing. Alternatively, a continuous flow processing system may be used, which we will describe in more detail later. The system of FIG. 1 comprises a photoreactor chamber 110 which is configured to receive UV or VUV from an emission source 120. The photoreactor chamber 110 is connected in a flow circuit 140 which is a loop around which a gas or liquid for processing may be driven by pump 130. The flow circuit may comprise tubing through which the gas or liquid for processing can flow. The photoreactor system further comprises an inlet or feed 170 through which the gas or liquid for processing is introduced. Since the photoreactor of FIG. 1 operates in a batch mode, we will use the term “charge” to describe the quantity of reactant used to fill the system. For a continuous process, as we will describe later, the terms “feed” or “product” may be used to describe the reactant. FIG. 1 also shows an outlet or drain 150 is provided, which is for draining or removing the charge after processing. A drain valve 152 is provided, for example, between the flow circuit 140 and drain 150 for stopping or allowing the charge to be removed from the system. The photoreactor chamber 110 may be a metal chamber with one or more windows for receiving the VUV (or UV) there through. Alternatively, the chamber may be formed of glass with low absorption of VUV and/or UV such as synthetic quartz. Optionally, the photoreactor system may comprise a buffer vessel 172. This may be provided on the feed 170 to the system. During processing the volume of the charge may change, for example due to expansion through heating or by reaction into different species. The buffer vessel 172 provides an expansion volume for the charge to expand into during processing. The buffer vessel may also provide a further volume of charge to be provided to the flow circuit if the volume of charge reduces such as if some charge is used up during processing. The buffer vessel may also provide temporary storage for additional charge beyond that currently being processed, such as after the current charge has completed processing. For a continuous flow photoreactor a buffer vessel is not needed because the continuity of flow of feed and product compensates for volume changes. The system of FIG. 1 may optionally further include a vent 160 and vent valve 162. The vent is to allow gases produced during processing to be vented from the system avoiding pressure build-up. Venting may be controlled by the vent valve 162. A gas separation device (not shown) may be used to separate out gas from liquid charge, which is then vented. In the embodiment of FIG. 1 the flow circuit 140, pump 130 and photoreactor chamber 110 form a closed loop. Not shown in FIG. 1 are system monitoring and control devices which may for example monitor and control any or all of flow rate, pressure and temperature within the system. The system 100 of FIG. 1 is a recycle photoreactor system.

Operation of the system of FIG. 1 will now be described. The steps of the operation of the system are set out in the flow diagram of FIG. 17. Charge is introduced via feed 170 into flow circuit and photoreactor chamber 110 (step 911). The pump 130 is cycled and the UV or VUV source is turned on (step 913). The UV or VUV is incident on the charge in the photoreactor chamber 110 causing remediation of the charge. Further details of the possible remediations will be described in the following. The pump is cycled for a period while the VUV source is irradiating the sample (step 915). After a sufficient period of cycling and irradiating, the charge will have been processed and the drain valve will be opened to drain down the charge (step 917). After draining, the drain valve may be closed and a new charge input via feed 170 (step 919). Testing may occur during processing or processing may be periodically interrupted to sample the charge for completion of the remediation.

The system is known as a recycle photoreactor because the charge is cycled around the flow circuit during processing. When discussing the charge circulating around the recycle photoreactor flow-circuit, the charge may be described as recycle fluid. Alternative photoreactor systems and reasons for the preferred scheme of FIG. 1 will now be described.

A design alternative to the recycle photoreactor of FIG. 1 is a tank with stirrer. The tank should be completely transparent to VUV or have a VUV transparent window through which the VUV is directed. A tank system needs to large enough to accommodate a stirrer. Heating of water in large volume such as a tank may also be less controllable than the recycle type flow reactor.

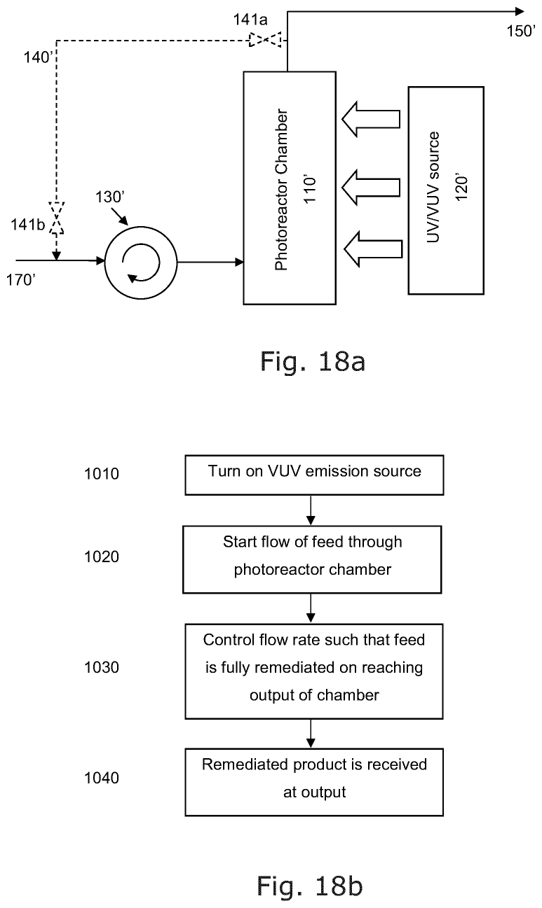

In an alternative embodiment, a continuous flow photoreactor system is provided. FIG. 18a is a schematic diagram of a continuous flow photoreactor system based on the batch system of FIG. 1. FIG. 18b is a flow chart relating the system of FIG. 18a. The system of FIG. 18a comprises a photoreactor chamber 110′ which is configured to receive UV or VUV from emission source 120′. The emission source may the emission source described herein. The photoreactor chamber 110′ and emission source 120′ are similar to the photoreactor chamber 110 and emission source 120 of FIG. 1. In FIG. 1 the photoreactor chamber 110 is connected in a loop around which the gas or liquid for processing is cycled. In the embodiment of FIG. 18a there maybe no loop or a loop 140′ may be optionally provided. The system comprises an inlet 170′, flow piping leading to and from the photoreactor chamber, and an outlet 150′. The feed is directed to the input 170′ and the products and waste are output at the output 150′. The feed may be driven into and through the photoreactor by pump 130′. Similarly to FIG. 1 the flow through the photoreactor chamber is in the vertically upwards direction. While this may have advantages, as set in relation to FIG. 1, other configurations are also possible. If the direction of flow of the feed is downward it may be possible to omit the pump because the feed may flow through the photoreactor chamber under force of gravity. Since for the embodiment of FIG. 18a there may be no recycle loop, to obtain remediated product at the output with minimal amount of feed, the residence time in the photoreactor chamber is controlled. This may be by adjusting the speed of the pump, for example. Where no pump is included, the size of an entry aperture, or exit aperture, from the photoreactor chamber may be controlled. The results of testing of output species may be used to adjust and control the flow rate through the reactor to maximise products and minimize unremediated feed at the output.

When an optional loop 140′ is provided it may be provided with flow controllers 141a and 141b located at the entrance and exit to the loop respectively. The flow controllers 141a and 141b control the flow through the recycle loop and may be valves or variable size apertures. The rate of flow of the feed may be controlled in tandem with the recycle flow to modify the residence time in the photoreaction zone in tandem with the hydrodynamic conditions in the photoreactor. The amount of recycle, which could be quantified as a recycle ratio (recycle flow:product flow) could be from 0:1 where there is no recycle and the feed/products flow through the photoreactor once, to 1:0 where there is no continuous flow and instead the feed is batch filled. The choice of recycle ratio is dependent on kinetics of the reaction.

Additional to the items shown in FIG. 18a, a reservoir or vessel of feed, such as liquid or gaseous feed may be included at the input. A similar reservoir or vessel of products may be provided at the output. Further processing may require the separation of waste products from the desired products. Also not shown in FIG. 18a is a vent such as vent 160 of FIG. 1. Continuous flow will mean that gaseous products will be less likely to become trapped in the system but a vent could still be provided to the photoreactor chamber.

In the embodiments of FIG. 18a, the emission source 120′ may extend along the length of the photo reactor chamber such that feed is continuously remediated as it moves through the chamber. The emission source will need to be high intensity. The higher the intensity the more quickly the feed will be fully remediated, reducing the size of the chamber and/or the residence time in the chamber.

Operation of the system of FIG. 18a will now be described. The steps of the operation of the system are set out in the flow diagram of FIG. 18b. The VUV source is activated (step 1010) such that as soon as feed enters the chamber the VUV can begin the photoreaction process. The feed is introduced via input 170′ into flow piping and photoreactor chamber 110′ (step 1020). The flow rate through the photoreactor chamber is controlled (step 1030) to fully remediate the feed. The control may be by controlling the speed of the pump 130′. The remediated product is received at the output (step 1040). Optionally, the recycle loop 140′ may be activated and the recycle ratio may be adjusted in tandem with the feed flow rate.

### Reaction Mechanisms

In the preceding it was described how the absorption of VUV by water at 172 nm is greater than that at 184 nm and consequently more hydroxide radicals, HO, will be produced. Water is known to have a high absorption for 172 nm UV. A measure of absorption is linear extinction coefficient, which is related to the reciprocal of the distance through the medium it takes for the radiation to have been absorbed or attenuated to 1/e of its original value. For water the linear extinction coefficient is 575.4 cm⁻¹. The energy carried by 172 nm UV photons (7.21 eV) creates HO· radicals in water. The initial photolysis reaction can be described as follows (for wavelengths less than 190 nm):

H₂O→HO·+H·

H₂O→HO·+H⁺+e⁻

The quantum yield for these two initial reactions is 1.0. Following these initialisation reactions, a web of interrelated free radical reactions and intermediates are considered to occur. The overall quantum yield for generation of HO· radicals in liquid water is 0.42 at 172 nm.

VUV is absorbed strongly by organic compounds and is capable of dissociating organic bonds creating reactive free radicals in the process. Organic compounds in the water have a high absorption cross section for VUV. This means that the quantum yields can be very high. As an example, methanol has a linear extinction coefficient approximately eight times that of water (4000 cm⁻¹). The photochemical reactions of methanol proceed according to the following reactions resulting in a total quantum yield for HO· radicals of 0.88 at 185 nm.

CH₃OH→CH₃O+H· Quantum Yield=0.69

CH₃OH→HOCH₂+H· Quantum Yield=0.08

CH₃OH→CH₂O+H₂Quantum Yield=0.06

CH₃OH→CH₃+HO· Quantum Yield=0.05

The rates of reaction, and therefore the conversion of reactants in a given residence time will be determined by the concentration of HO· radicals generated rather than from interactions between VUV and the dilute contaminants themselves. Although organics are strong absorbers of VUV, it may be more likely that a given VUV photon will encounter a water molecule with which it will interact to form HO·. It follows that the principle reaction routes will be from interactions between organics, and HO· as well as intermediates from subsequent chain reactions.

The quantity of HO· generated is directly proportional (via quantum yield) to the number of photons supplied. Therefore, a higher intensity of UV or VUV will increase the HO· concentration within the reaction. Furthermore, the use of lower wavelength VUV (higher energy) is likely to increase quantum yields.

Another factor considered in the design of the photoreactor system is how deeply the VUV penetrates water. Water absorbs 99% of 185 nm light within 11.1 mm whereas 99% of the 172 nm light is absorbed after only 0.035 mm. This means that for 172 nm light, the HO· radicals will not be evenly distributed throughout a sample because the VUV photons cannot penetrate far into the water before they are absorbed. The concentration of HO·, and thus the reaction rate and conversion, is likely to be highest near to the source of the VUV. In the embodiment of FIG. 1, this will be close to the walls or windows of the photoreactor chamber 110 where the VUV enters the chamber.

In the embodiment of FIG. 1 the charge is cycled around the flow-circuit, including the photoreactor chamber 110. The thickness of the boundary layer (laminar sub-layer) in the fluid flowing in the photoreactor close to where the VUV enters the chamber is therefore likely to influence the rate of reaction. However, the diffusion coefficient of HO· in water is high so diffusion into the bulk fluid is likely to be rapid. The rate of diffusion may be slower than the rate of depletion of HO· from the charge and therefore diffusion may be the rate-limiting step in the reaction mechanism.

The thickness of the boundary layer and thus its effect of diffusive flux is largely dependent on the turbulence within the flow. Turbulence can be introduced by increasing the flow velocity, but careful design and control is required to prevent vibrations that may damage components. Baffles may additionally, or alternatively, be added to introduce turbulence.

In considering photoreactor design, a batch photoreactor allows the charge or sample to be maintained in the photoreactor chamber until remediation is complete or, at least, sufficiently advanced. As discussed, a continuous flow mode operation system is an alternative configuration. For continuous flow, the flow rate may be controlled to adjust the residence time to achieve complete remediation of the feed. As discussed above, a batch photoreactor could be made from a tank that may be transparent, such as made of glass, with a stirrer, or it may consist of a flow-through tube within a recycle loop as for the recycle photoreactor described herein. In the recycle photoreactor, the local intensity of radiant energy per unit volume of reactor is higher than it would be for a stirred tank design of equal volume. This will reduce the effect of competition with HO· by intermediates leading to a greater overall conversion with lower levels of intermediates. Accordingly, the recycle photoreactor, such as the embodiment of FIG. 1, is preferred for batch processing.

In the embodiment of FIG. 1 the reaction rates are likely to be determined by the penetration of VUV and diffusion of HO· from the walls of the photoreactor into the bulk fluid. Gas bubbles formed from oxidation products such as CO2 may absorb VUV and higher diffusive boundary layer thickness will decrease the diffusive flux rate of HO· into the bulk fluid.

Gas bubbles of reaction product are likely to originate on the glass surface of the photoreactor chamber, or window thereof, where the intensity of VUV is highest. Any bubbles on the surface of the photoreactor may slow the reaction rate because CO2 will absorb VUV. If fluid flow in the photoreactor is too slow, the bubbles may not detach from the walls and rise until they become sufficiently large. Preferably, the photoreactor chamber is arranged vertically with the flow direction of the charge through the chamber in the upwards direction. This reduces the likelihood of bubbles being trapped in the chamber. The bubbles may be vented off at vent 160. These comments apply for the charge being a liquid, but for a gas the flow direction is less important because reaction products will more readily disperse. For liquids, an alternative approach to arranging the flow direction vertically upward is to have a downward flow in which the flow rate is faster than the velocity at which the bubbles rise, although this is likely to be less preferred than the vertically upwards arrangement.

The system of FIG. 1 preferably operates under turbulent flow conditions to aid bubble detachment from the walls as well as reduce the thickness of the laminar sub-layer as far as practicable. Under static or laminar flow conditions, the boundary film layer on the surface will be thicker than it would be under increasingly turbulent flow. A thinner boundary layer represents a lower resistance to diffusion of HO· into the bulk fluid. This increases the overall rate of reaction because, as discussed above, the diffusion of HO· is likely to be the rate limiting step because all other reactions are fast.

The preferred arrangement of FIG. 1 is a tubular reactor with a VUV transparent window, close to which there is a ‘photoreaction zone’. Another advantage over the tank design is that the recycle photoreactor volume may be small if the flow is rapid through the reactor and around the flow circuit loop.

The recycle photoreactor may be fitted with a heat exchanger (not shown) coupled to the flow circuit, such as a pipe, or the chamber. The volume in the recycle photoreactor can be adjusted via the addition of larger or longer sections of flow circuit or pipe. Continuous flow may also be possible if the VUV intensity and cooling is sufficient to react all required species and maintain the water cool. Banks of tubes may also be possible, for example, if it is desired to keep the cross-section of the tubes low enough and to increase the area receiving VUV since the VUV will be rapidly absorbed by the water in a short thickness of charge. The banks of tubes may be illuminated by one lamp or by a separate lamp for each tube.

Turbulence and the number of ‘passes per minute’ through the photoreaction chamber in the recycle photoreactor can be adjusted via the pump speed and velocity of flow. The batch and recycle nature of the system of FIG. 1 means that the overall residence time in the photoreaction section is independent of the flow velocity. This allows the relationship between turbulence and reaction rate to be adjusted for optimal photoreaction.

The recycle photoreactor provides advantages for the rates of reaction within the system. A high irradiation intensity per unit volume on a local scale for the recycle photoreactor (as compared to a tank) raises the local concentration of desired reactive intermediates and therefore increases the likelihood of a more complete reaction.

### Corona-Discharge VUV Source

While a number of VUV sources exist in the prior art, a problem exists in that prior art devices cannot be scaled easily. As mentioned earlier in this disclosure a paper by Salvermoser and Murnick, “Efficient, stable, corona discharge 172 nm xenon excimer light scource”, Journal of Applied Physics, 94(6), pp 3722-3731, describes a corona-discharge based VUV lamp. We now describe operation of a corona-discharge based VUV lamp.

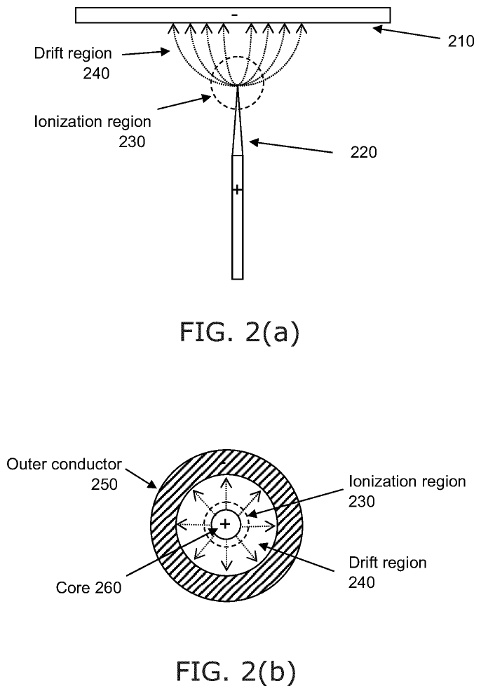

A corona discharge is a field-driven discharge where, due to geometry, the region of ionization is limited to a small ionization region. By ‘field’ we mean an electrostatic field, although time-varying fields can create corona-discharges provided that the frequency of variation is sufficiently small. Accordingly, corona discharges can be generated by high voltage (HV) DC sources or low frequency HV AC sources. Corona discharges can be generated using a wide range of configurations. Normally, these discharges are driven by high voltage, HV, that is, multi-kV DC power supplies, such as in the range from kV to tens of kV. The electric field may be enhanced by geometry. For example, as shown in FIG. 2a, geometrical enhancement of the field is provided by a needle 220. An alternative arrangement of geometrical enhancement is a wire, as shown in FIG. 2b. In both of these arrangements the geometry focusses or concentrates the electrical field spatially. For example, in FIGS. 2a and 2b a small radius (such as for the wire) or a point on a needle electrode concentrates the electric field leading to a high field. If the field is concentrated sufficiently and the voltage is sufficiently high, then the gas near to the electrode is ionised. The region of ionization 230 extends up to a distance where the ionisation rate balances the rate of loss of ions and/or electrons. In the needle case, the ionization region 230 is confined to the tip of the needle 220, whereas for the wire it is a coaxial region 240 extending along the core or centre conductor 260 of the wire. These examples are shown in FIGS. 2a and 2b.

In FIG. 2a the point of the needle 220 is connected as a positive terminal and in FIG. 2b the centre conductor 260 of the wire is connected as a positive terminal. Since in both of these cases the corona discharge is at the positive terminal it is called a positive corona. If the point of the needle or the centre conductor of the wire were connected as negative terminal then it would be a negative corona.

Outside of the ionization region 230 is a region known as the drift region 240 where electrons or ions flow between the electrodes without causing ionization. This drift region 240 is a key feature of a corona discharge compared to other plasma discharges. In FIG. 2a a plate 210 is connected as a negative terminal and the drift region is between the ionization region and the plate. In the figure electric field lines are shown extending from the tip of the needle 220 and spreading out towards the plate 210. In FIG. 2b coaxially spaced from the centre conductor of the wire 260 is the outer conductor 250. The drift region 240 is between the ionization region 230 and the outer conductor 250. The electrons or ions are driven from the ionization region to the plate or outer conductor and deposit energy in to the gas, which is used to generate VUV. Since in FIGS. 2a and 2b the needle and core are positively charged, ions will be the charge carrying species emitted from the needle and core. If the needle and core are negatively charged then electrons will be emitted and driven by the field towards the plate or outer conductor.

The ability to use the drift region to deposit energy in to the gas and generate VUV depends on the current-voltage relation for the corona discharge. The current-voltage relation determines how much power can be deposited in the drift region at any given voltage. The necessity for geometrical enhancement also complicates matters because most other geometries would not provide the required enhancement. Furthermore, the field reached in the ionization region is close to the breakdown field of the gas so careful design of the geometry should be considered.

In the arrangements of FIGS. 2a and 2b the physical area for current injection from the cathode must necessarily be limited by geometrical enhancement of the field. If achieving a high field was not necessary, then the cathode area could be used to scale the discharge.

### Theory

We now consider how power of the corona discharge can be scaled. If we consider fluid theory in planar geometry the governing equations are Poisson's equation, the continuity equation (for charge and current), and the current-field transport relation:

∇·E=−enₑ/εo

∇·je=0

je=−enₑμₑE

These can be used to describe a steady-state, but flowing, charge distribution set up between two parallel plates set a distance L apart. In 1D planar geometry, where the current density is a constant, we can solve this system to yield,

Eₓ=−√(2j₀X/ε₀μₑ)

under certain conditions, (for example, the electric field goes to zero at the cathode, x=0). So if we have a system of length L, with a voltage, V, applied between the two plates, then integration and re-arrangement yields a current density, j:

j=(9/8)ε₀μₑ(V²/L³)

This gives us an I-V relation for the system. If we set the area of the plates to be A, the power dissipated must then be,

P=(9ε₀μₑ/8)(V³A/L³)

Since the permittivity and mobility are fixed by basic physics, the three controllable parameters are the voltage, the spacing between the plates, and the anode or cathode area. Effectively we have added the area as a linear way to scale up the discharge power. This would be unlike conventional corona discharges where the cathode area becomes set small by the need to self-generate the ionization region through electric field enhancement. Accordingly, having shown a planar geometry can be used to scale up the power, there remains a need to be able to produce an ionization region independently of the geometry.

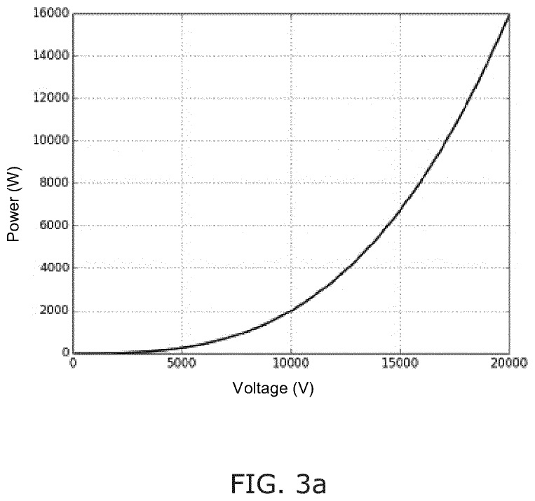

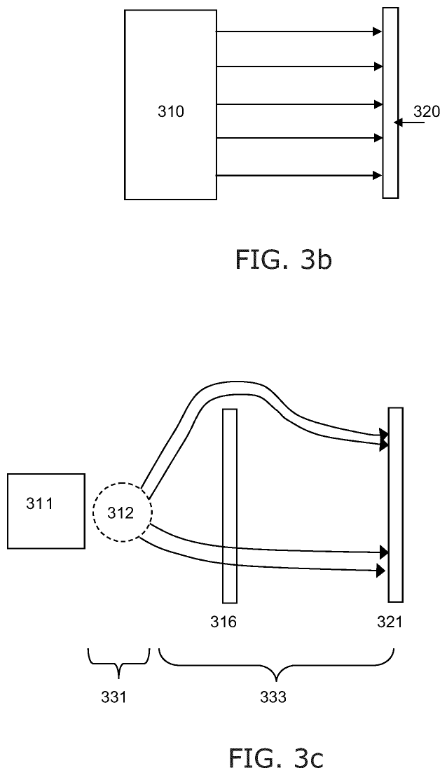

This increase in power is shown graphically in FIG. 3. For example, if we consider increasing the area for the case of Xe, take L to be 1 cm, and have a 3 by 3 cm area, then we should be able to reach 1.4 kW of power discharge for 20 kV applied voltage across the plates. If we can scale this to a 10 cm by 10 cm area then we can reach 16 kW for 20 kV, and it we further scaled this to only 30 cm by 30 cm, then we could reach 90 kW for 20 kV. The increasing power for 10 cm by 10 cm plates is shown in FIG. 3 and can be seen to increase in proportion to the cube of the voltage.

Increasing the voltage and increasing the area over which it is applied allow a higher current to be driven and increases the number and energy of the ions and electrons being driven.

In considering the needle/plate of the VUV corona discharge based source described above, the area A is small for the needle and limits the amount of discharge power.

### VUV Source Embodiments

FIGS. 3b and 3c show example embodiments of arrangements for increasing the area across which ions or electrons can be driven so as to increase the amount of discharge power.

FIG. 3b shows an electron or ion source 310 that has an extended area. The electrons or ions are driven by a high voltage electric field between the source 310 and electrode 320. The area of emission of electrons or ions from the source and the area over which the electrons or ions are received at the electrode 320 are similar to each other and are larger than the area provided by the needle or core in FIGS. 2 and 2b. Hence, an increase in discharge power may be achieved.

FIG. 3c shows an alternative arrangement in which device 311 generates a plasma at 312. Ions or electrons from the plasma are driven towards plate electrode 321. The ions or electrons may be driven to the plate electrode 321 by two different or complementary routes. Second electrode 316 is oppositely charged to the electrode 321. Ions or electrons from the plasma may be accelerated around and past the second electrode 316 towards the electrode 321. Alternatively, second electrode 316 may be perforated with a series of holes. The electrons or ions are accelerated through the holes towards the electrode 321. For example, if the plasma 312 is formed of electrons and/or negatively charged ions, the second electrode 316 may be negative and the electrode 321 may have a positive voltage to attract the negatively charged species towards it. Alternatively, the plasma may comprise positively charged ions and they may be accelerated towards electrode 321 by having a negative charge thereon.

The problem with the arrangement in FIG. 3b is that it is difficult to generate a large area high voltage and this is the reason the corona discharge has been used in the prior art. The enhancement provided by the geometry results in a higher field in regions resulting in the corona discharge. To produce a sufficiently high electric field over a large planar area may require 100kVs.

The arrangement of FIG. 3c allows a localised plasma 312 to be generated by device 311. Ions or electrodes are then driven, over a wide area to the electrode 321. This achieves the effect of increased area so as to allow more power to be supplied to the discharge. The region where the electrons or ions are generated may be thought of as an electron source region or ion source region, which is shown as 331 in FIG. 3c. Similarly, to the corona discharge the region where the electrons or ions are driven from the source to the electrode 321 may considered to be a drift region.

FIG. 3b relates to wide-area electron or ion source, whereas FIG. 3c relates to the generation of a localised plasma. There is an intermediate arrangement where a localised source generates ions or electrons and are still driven around, or through perforations of, the second electrode 316 such that the ions are driven towards the electrode over a large area.

In the arrangement of FIG. 3c the generation of the electrodes or ions at region 312 is separate to the requirement of driving the electrons or ions over a large area to electrode 321. Hence, it becomes possible to use techniques for generating the electrons or ions which are separate and different to the high voltage required for driving the electrons or ions. Accordingly, electrons or ions may generated by means other than HV such as by microwaves or other means.

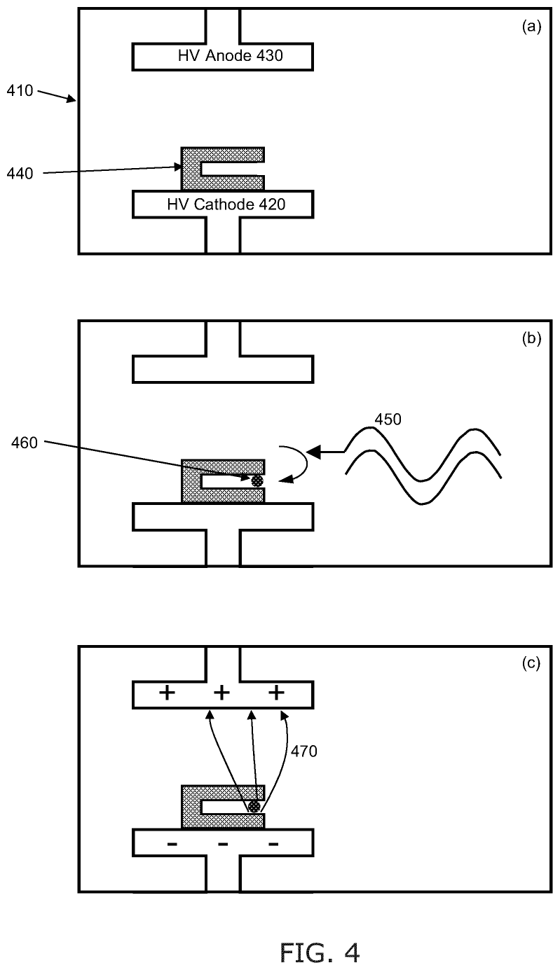

FIGS. 4a-4c schematically show operation of a VUV or UV source according to a preferred embodiment of the present invention. The figures show a chamber 410 in which is provided a cathode 420 and an anode 430. On the cathode is a resonator 440 but other positions for the resonator are possible. The resonator provides a convenient means for increasing the localised intensity of the microwaves to form the plasma. However, in an alternative arrangement the resonator may not be used and an increased power of microwaves may be supplied to the chamber. It is preferable if a resonator is used because the amount of microwave power required to form a plasma may be reduced thereby allowing a microwave source of lower cost to be used. For VUV or UV emission, the chamber preferably comprises an excimer forming gas such as xenon gas.

Returning to FIGS. 4a to 4c the anode 430 and cathode 420 are generally planar parallel plates spaced from the walls of the chamber. At least one of the anode 430 and cathode 420 should be electrically insulated from the chamber walls to avoid short circuit. The resonator may take different forms, and/or multiple resonators may be used, but as shown in FIG. 4a a single resonator may be used which is shaped like jaws of a mouth, for example, with a slot, channel or opening in the structure. The chamber 410 is configured to receive microwaves 450 from a microwave source. As shown in FIG. 4b, the microwaves generate a plasma 460 in or near the mouth or jaws of the resonator. The anode 430 and cathode 420 are connected to a high voltage. When turned on the high voltage drives electrons or ions from the plasma. For example, electrons may be driven from the plasma to the anode as shown by the arrows 470 in FIG. 4c. After the plasma has been initiated, the amount of microwave power supplied can be reduced because only a small power level is required to maintain the plasma.

We have previously discussed that it would be desirable to increase the area of the drift region so as to increase the power that can be output. In FIG. 4c the plasma appears to be small and is located between the jaws of the resonator. When the high voltage is applied electrons are driven from the plasma and have to travel around the top jaw or plate of the resonator 440. This results in an effective increase in the area over which electrons are driven to the anode, thereby increasing the power that can be applied or injected. The greater the power that can be injected, the greater the amount of VUV that will be emitted. Instead of forcing all of the charged species around the top jaw or plate of the resonator, the top jaw or plate may be perforated such that electric field lines pass through the holes. Thus, a combination of forcing the charged species to travel around the edge of the top jaw or plate, and perforating the top jaw or plate, may spread out the flow of charged species to increase the area of electron flow.

In more detail, microwaves are directed at the resonator to induce a plasma. The resonator may be located on or may form a first electrode. A second electrode is provided spaced apart from the first electrode. The plasma may be formed of ions and/or electrons. Depending on whether electrons or ions are formed in the plasma will determine whether the second electrode is an anode or cathode. The charged species are driven from the plasma to the second electrode by the appropriate attracting charge on the second electrode.

The microwave source generates the plasma, and the voltage applied between the electrodes provides the driving force for driving the charged species through the excimer gas to excite the excimer atoms and produce VUV emission. This is different to the corona-discharge based VUV source described above which uses a needle and plate. In that arrangement, the DC electric field alone generates the corona discharge (partly because of the geometric enhancement provided by the needle) and the electric field also drives the charged species through the excimer gas. By separating the charged species generation from the driving of the charged species through the excimer gas, the power can be increased without resulting in electrical breakdown of the gas or without arcing occurring. In FIGS. 2a and 2b we described an ionization region around the needle or centre conductor where a corona discharge was located. Charged species then flow, such as from the ionization region through the drift region colliding with excimer atoms to excite them and produce VUV. By spreading out the flow of charges species such that the area over which the charged species are flowing from one electrode to the other, allows more current to flow and hence more power to be input, as discussed above. The region at or close to the plasma in FIGS. 4b and 4c may be considered to be, as described in relation to FIGS. 3b and 3c, an electron source region and the region between the top of the resonator and the second electrode corresponds to the drift region in FIGS. 2a and 2b. The term “electron source region” is used instead of “ionization region” because ionization may be considered to refer to generation of charged species by an electric field, whereas the microwaves produce a plasma thermally.

In an embodiment, the microwave source may be a 2.45 GHz microwave source. Such sources are widely available at relatively low cost since they are the microwave source used in microwave ovens. The resonator may be considered to focus or concentrate the microwaves such that less power is needed in order to ignite a plasma.

FIG. 5 schematically shows the components that may be needed for operation of an emission source comprising the chamber shown in FIGS. 4a-4c. A microwave source 520 such as a 2.45 GHz magnetron is arranged to direct microwaves into the chamber 510. Preferably, the microwaves are supplied from the microwave source by a rigid waveguide having metal walls and air filled cavity. Alternatively, microwaves may be supplied by a coaxial cable. The microwave source should have the capability to adjust the output power of microwaves, or alternatively an attenuator may be provided such that the power level of microwaves entering the chamber may be controlled. A voltage source 530 is required to provide a voltage such as a DC voltage across the first and second electrodes. This may be a high voltage DC, or HV source. By HV we mean a source capable of producing a voltage in the order of kV, such as greater than 1000V and into the 10s of kVs. High voltage or HV is alternatively defined as a voltage capable of producing harm to living organisms. The IEC defines high voltage as greater than 1500V DC or greater than 1000V DC. Although a DC or substantially steady-state voltage is preferred, in embodiments it may be possible to use a slowly varying AC voltage. However, such a slowly varying voltage would only be possible up to a few Hz, and generally less than 10 Hz. Above this frequency, the change in polarity would be too fast for the drift of electrons or other charged species to be established. In this disclosure when we refer to DC we generally mean DC or slowly varying AC.

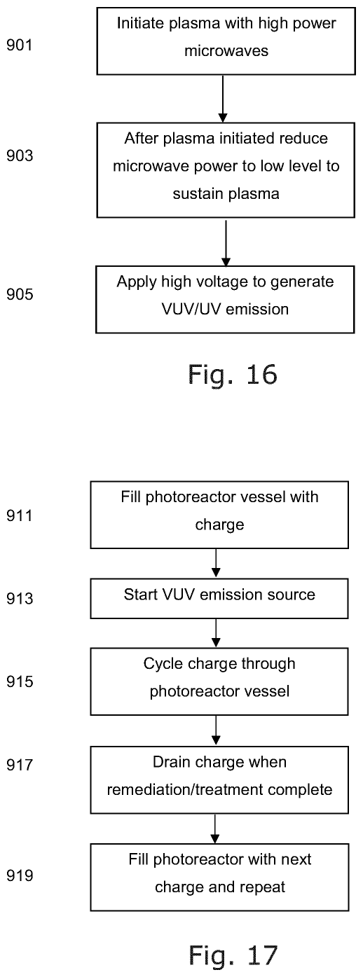

A controller may be included that controls when to turn on the microwave source and the HV source and the corresponding power or voltage levels needed to sustain VUV emission. The controller may include a memory and microprocessor. A method of operating the microwave source and HV source is provided in FIG. 16. The controller may be configured to operate the microwave source and HV source, according to the method, as follows:
1) Turn on the microwave source to generate a first power level of microwaves for injection into the chamber to ignite the plasma (step 901);
2) Control the microwave source or an attenuator to reduce the power level of microwaves to a second level, lower than the first, sufficient to sustain the plasma (step 903); and
3) Control the HV source to turn on or increase the voltage between the electrodes to drive the electrons or ions from the plasma to generate the excimers in the gas and produce the vacuum ultraviolet or ultraviolet emission (step 905).

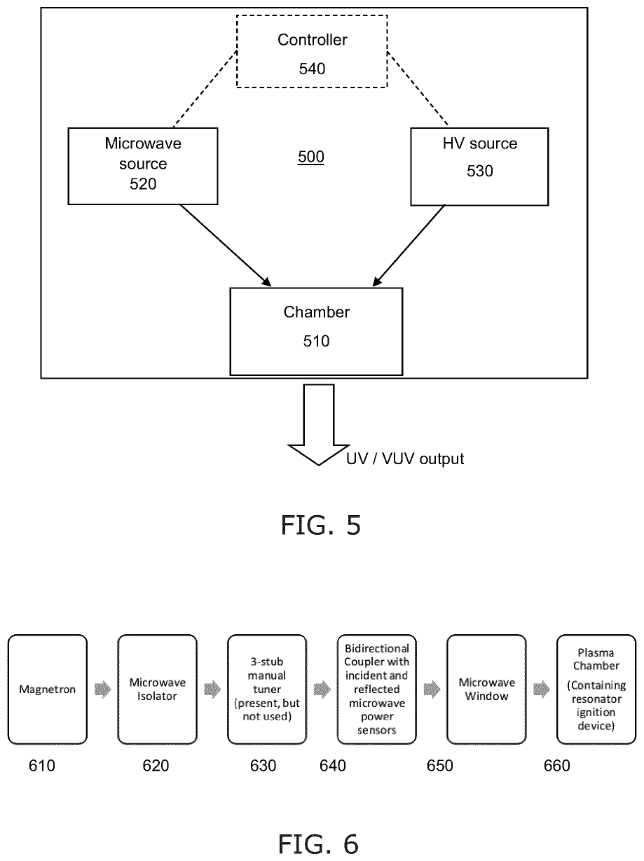

FIG. 6 is a block diagram providing further details of an embodiment of the microwave arrangement that may be used to supply microwaves to the chamber such as chamber 410, 510, and indicated as 660 in FIG. 6. The microwave source may comprise magnetron 610. In an embodiment the microwave source is a 2 kW source and may provide the microwaves at 2.45 GHz. The microwave source may be capable of providing continuous or pulsed microwaves. Microwaves may be supplied from the microwave source, such as to the various components in FIG. 6, or direct to the chamber by a waveguide such as WR340 waveguide which is a rectangular waveguide suitable for supporting the TE₁₀ mode at 2.45 GHz. After the microwave source may be provided a microwave isolator 620 to protect the source, such as a magnetron, from back reflection of microwaves. The microwave isolator may be water-cooled. A tuner 630, such as a manual three-stub tuner may be provided after the isolator to match the RF impedance and avoid parasitic reflections and standing waves being set up. A bidirectional coupler 640 may be used to couple power to microwave power meters to measure incident and reflected microwaves powers during operation. The chamber itself 660 is reached through a microwave transparent window 650. The chamber 660 may comprise a waveguide with a rear short circuit panel to reflect microwaves. The rear short circuit panel may be positioned at the end of the waveguide and may be isolated from the rest of the equipment by the microwave window.

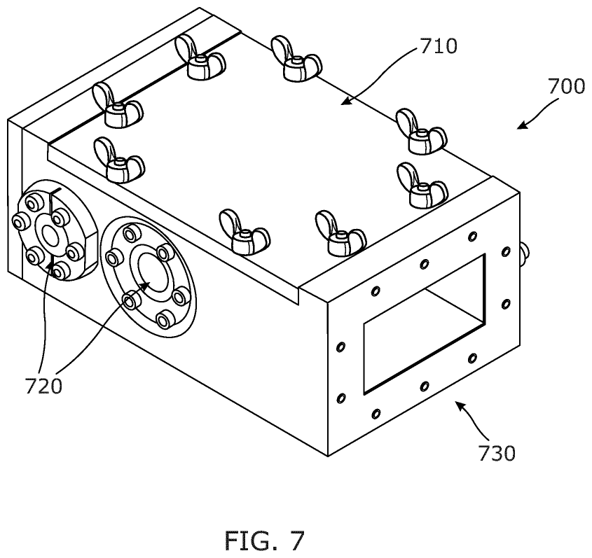

FIG. 7 is a perspective drawing of an embodiment of the plasma chamber which is indicated by reference number 700 in the figure. The plasma chamber may be configured to allow easy access via a removable top panel when used as a test device. In manufactured products the chamber would not require such a panel. In a preferred embodiment the chamber is formed of a hollowed or machined-out metal block. This may be of a substantially unitary construction with flanges for connecting cut out holes to gas ports, electrodes and windows. This construction may not require seals, or at least minimizes the number of seals between plates forming the chamber, so as to more easily maintain the desired pressure and gas fill, and which is easier to pump down. The chamber is configured for operation at any pressure from slightly above atmospheric to vacuum, although preferably operation is at close to atmospheric or sub-atmospheric. In preferred embodiments the pressure is between 0.1 and 1.0 atm and more preferably at around 0.5 atm. The chamber in test form may include two gas ports 720 for gas fill and purging and evacuation of gas via a vacuum pump, but these are not be required in a manufactured device since the gas will be maintained in the chamber, although a top-up port may be included. The gas may be an excimer forming gas such as xenon. A window (not shown) is provided for emitting the VUV. The window may be borosilicate.

The chamber is designed to ignite plasma using continuous or pulsed microwaves at atmospheric pressure, sub-atmospheric pressure or close to atmospheric pressure as described in the preceding paragraph. Inside the chamber there is a short-circuited waveguide termination (to reflect microwaves). The window provides the VUV output or may be connected to a photoreactor. The waveguide is coupled to the end 730 which is shown as open in FIG. 7. The internal height, width and flange connection on the plasma chamber preferably all conform to the WR340 standard for microwave frequencies between 2.2 and 3.3 GHz (wavelength 122.4 mm in waveguide). In a particular embodiment, the internal length of the chamber is 190 mm measured from the waveguide front flange connection to the rear short-circuit termination. The width and height are 86 mm and 43 mm respectively.

The ignition element or resonator is preferably positioned at an area of peak electric field where ignition of plasma is easiest. If the resonator is a quarter-wave resonator, peaks in field occur at odd multiples of one-quarter wavelength (i.e. one quarter, three quarters, five quarters etc.). The wavelength is the longitudinal wavelength in a waveguide, which is different to the free space wavelength. The peaks are also equidistant from the walls and between the base and ceiling of the chamber. Positioning a quarter-wave resonator at any of these multiples makes ignition occur at a lower microwave power and create a more stable plasma. For 2.45 GHz microwaves, a quarter wavelength is 30.6 mm. In a preferred embodiment, the resonator is positioned at three quarters of a wavelength (91-92 mm) from the end termination. Similar analogues of this design could be produced for any wavelength giving sufficient field intensity to ignite plasma.

In a test device the gas ports were used to allow the chamber to be filled with argon or xenon gases.

### Resonator

The aim of the resonator is to reduce the microwave power required to ignite the plasma. Although coaxial designs are possible a resonator having a mouth or jaw configuration is preferred. Various resonator designs are possible but they should preferably maintain a high microwave absorption, produce a stable and static plasma and minimise the microwave power required to achieve ignition.

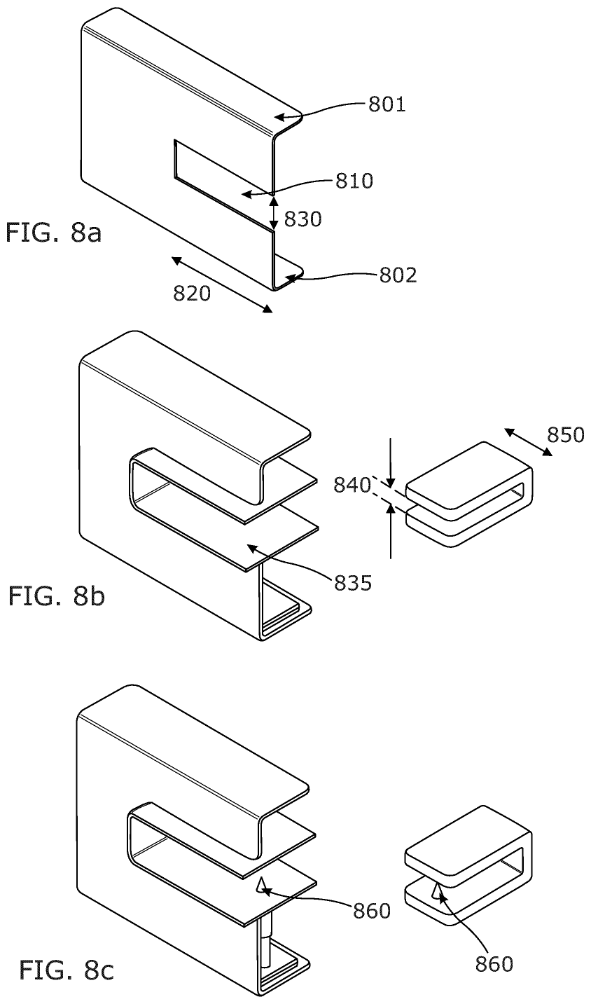

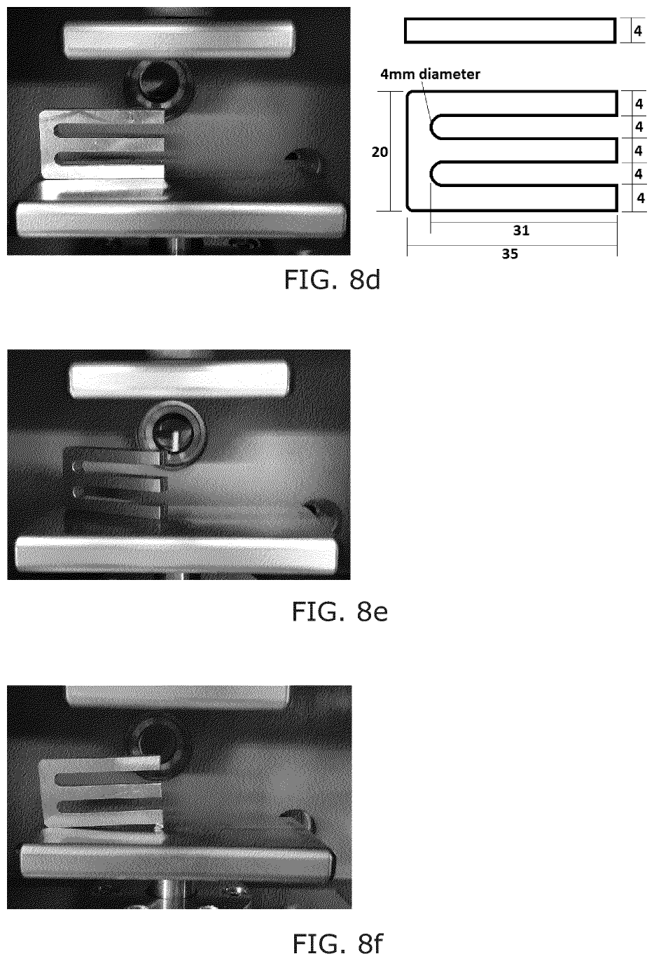

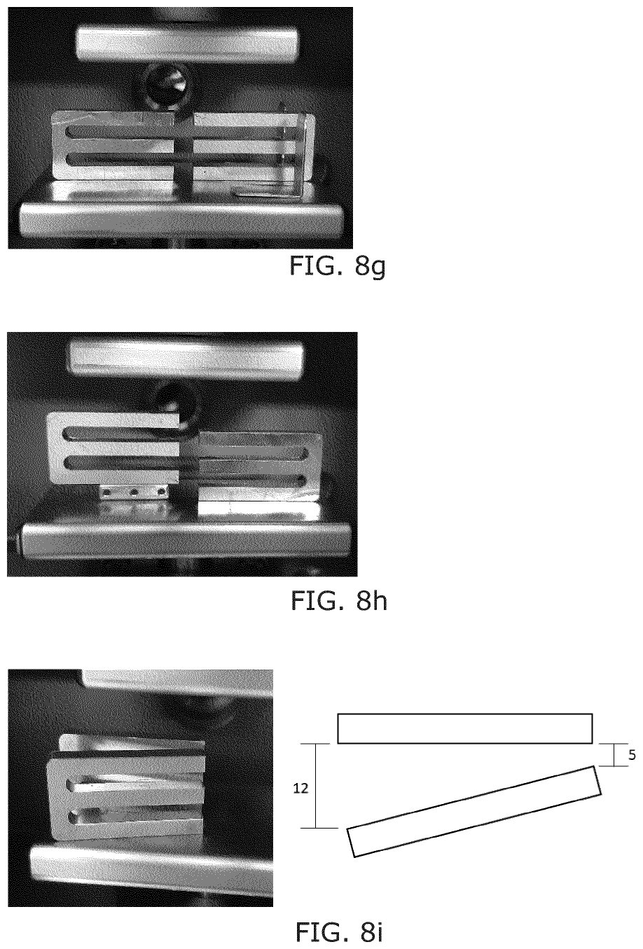

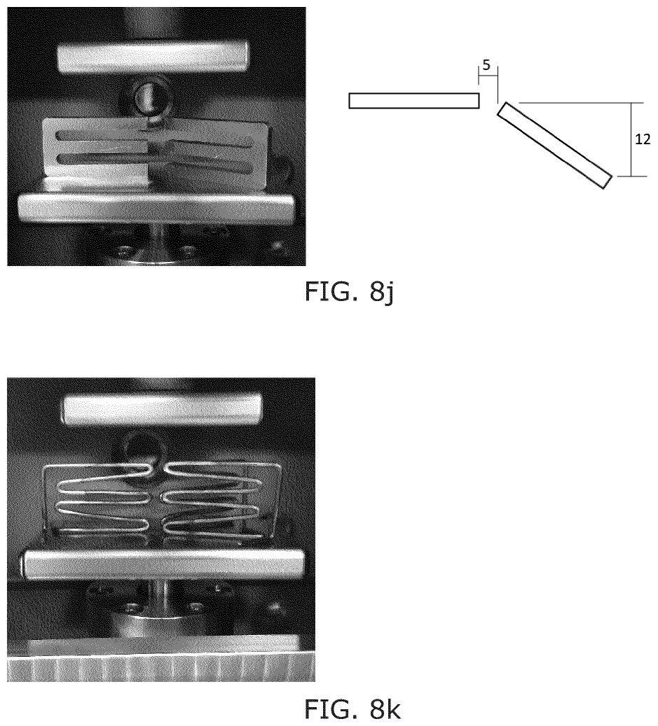

FIGS. 8a-8k show a number of resonator designs and arrangements, including single slot resonators, multi-slot resonators and resonator arrangements comprising multiple resonators.

FIGS. 8a-8c show three single-slot resonator designs. The resonator part of each is the slot or gap 810. The resonators shown in FIGS. 8a-8c are actually test resonators that would be supported between the top and bottom of the chamber. For example, the folded over tabs 801 and 802 at the top and bottom would contact, or be held, at the top and bottom of the chamber. We show these test resonators because they conveniently show three different resonator designs. In practice the resonator would comprise of the slot-forming part seated on one of the plate electrodes 420, 430, such as shown in FIG. 4.

We now describe various alternative resonator designs. All are quarter-wave resonators which means the length of the slot is a quarter-wavelength, which is indicated by 820 in FIG. 8a. The microwave field has high intensity at a quarter-wavelength from the end, or termination, of the slot. FIG. 8a shows a first embodiment of a single-slot resonator. FIG. 8b shows a modification to the slot-resonator of FIG. 8a which is known as the open quarter-wave resonator. FIG. 8c shows a further modification which is to include a pin field enhancement and the resonator is known as the open quarter-wave resonator with pin.

The resonator shown in FIG. 8a is based on planar design, with a slot cut into a vertical plate. The internal length of the quarter-wave resonator measured from mouth to rear wall when configured for a 2.45 GHz frequency measures 31 mm from the front to the rear wall. Ignition can be achieved for other lengths within +/−20%, namely between 25 and 37 mm, but is less efficient and reliable. If a different frequency of microwaves is to be used, the resonator length should be adjusted to one quarter of the wavelength used. The gap spacing 830 can be varied to whatever is practicable. A wider gap can make a longer plasma arc. However, a larger gap will require a higher microwave power to ignite plasma. Another consideration is that as the jaws become further apart and have closer proximity to the top or bottom of the waveguide or chamber, arcing may occur from the resonator to the edge of the waveguide or chamber. With the resonator of FIG. 8a a plasma is ignited with a brief filamentous discharge that stabilizes to form an arc. The plasma arc formed experiences some movement back and forth within the resonator, with occasional ejection of the plasma from the front of the resonator.

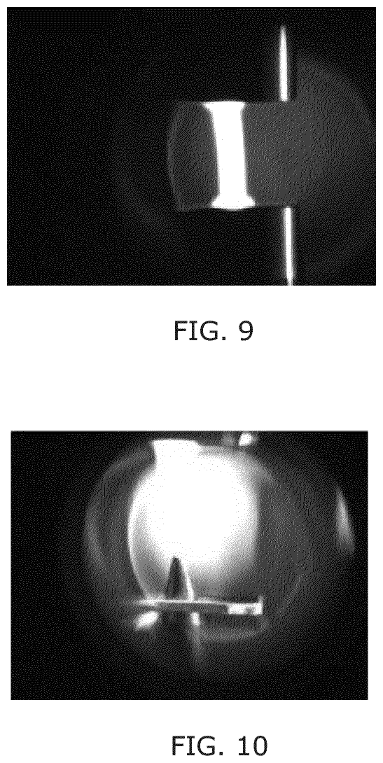

FIG. 8b shows the second design of resonator in which the jaws of the slot are widened by the addition of a U-shaped plate 835 inserted in the slot. The result is that the top and bottom jaws of the slot and the end termination are planar surfaces rather than the edge surfaces of the resonator of FIG. 8a. The planar surfaces forming the top and bottom jaws are parallel. The parallel planar surface widen the surfaces (as compared to FIG. 8a) between which the plasma is formed thereby increasing the uniformity of the field in the resonator region. In the device of FIG. 8a any damage to the upper and lower jaw of the resonator could result in them becoming misaligned resulting in a more unpredictable arc or plasma. The U-shaped plate 835, which is known as the “clip”, may be made of aluminium sheet, such as 1 mm aluminium sheet as shown in the left hand figure of FIG. 8b. Preferably, steel or tungsten is used to make the clip. In a preferred embodiment as shown in the right hand figure of FIG. 8b, the thickness of the plate is 4 mm, the width of the clip 850 is 20 mm and the gap spacing 840 between the top and bottom plates is 6 mm. Other dimensions may be used. The thickness and material used for the clip 835 will influence its durability and longevity, with softer metals lasting a shorter period of time. For tougher and/or thicker clips the clip is manufactured by machining. Plasma behaviour is more consistent for thicker machined resonators and overheating is less of a problem. For a gap spacing 840 of 6 mm a plasma is ignited in xenon at between 800 and 1000 W of microwave power. FIG. 9 shows a photograph of the plasma. The plasma initiates with a brief and bright filamentous discharge that rapidly stabilises to form an arc as shown in FIG. 9. After ignition, the plasma remains at the mouth of the resonator, predominantly at the corners. The plasma is not as mobile within the resonator as for resonator design of FIG. 8a but some motion occurs.

FIG. 8c shows a third single slot resonator design which is based on the “clip” or U-shaped plate of FIG. 8b, but includes a pin 860 to enhance the field within the resonator. The pin protrudes a small distance into the mouth of the resonator and is positioned a short distance from the front of the resonator. Based on a resonator of dimensions discussed in relation to FIG. 8b the pin was positioned to protrude into the mouth of the resonator 5 mm from the front at the centre. With this arrangement the resonator ignited a plasma at 400-600 W, which is a significantly lower power than for the resonator of FIG. 8b. The plasma was not mobile within the resonator and so provides a more uniform light emission in an emission source. FIG. 10 shows the ignited plasma in the resonator. The resonator of FIG. 8c is preferably manufactured from tungsten, which has a higher melting point than steel or aluminium. The pin does not have a role in concentrating the DC electric field, as in the prior art corona discharge schemes but tunes where the plasma forms.

FIG. 8d shows a multi-slot resonator. Here the aspect ratio (height:width) of the resonator is changed compared to FIG. 8c. The figure includes a photograph of the multi-slot resonator and a drawing including example dimensions. Multi-slot resonators preferably have two or three slots but greater numbers are also possible. The slots may be formed in a similar manner to those of FIGS. 8a-8c. Alternatively, the slots may be machined into bulk material, such as shown by the multi-slot resonator of FIG. 8d. The resonator of FIG. 8d is a plate resonator because the surfaces between which the resonance occurs are planar. This is the same as FIGS. 8b and 8c, whereas for FIG. 8a the ignition is between edges. The dimensions of the machined slots of the resonator of FIG. 8d are similar to those of the clip of FIG. 8c. The length of the slot is around 3 cm corresponding to a quarter wavelength of the microwaves in a vacuum. The gap remains at around 4 mm. The width of the resonator is reduced from that in FIG. 8c to 4 mm, 2 mm or even to around 1 mm. Other dimensions may be used taking into account the considerations described above in relation to FIG. 8c. FIG. 8d shows two slots with the slots stacked on top of one another. Similar to FIGS. 4a-4c the resonator may be located on the anode or cathode, but is preferably on the cathode. In the arrangement shown in FIG. 8d the microwaves would be incident from the right-hand side. The plasma will be ignited at the front of the slots and stabilize inside the individual slots or may arc along the front from one slot to the other. It is possible that ignition may occur in one of the slots only, such as the top slot.

FIG. 8e shows the same two-slot plate resonator as shown in FIG. 8e but the orientation of the resonator with respect to the incidence direction of the microwaves is changed. The resonator continues to have the slots facing the direction of incidence but the slot direction is offset by an angle of between 20 and 60 degrees such as by 30-45 degrees. FIG. 8f shows the resonator offset by angle again but in a different direction. The resonator is tilted with respect to the plane of the electrode. The tilt may be achieved by placing a support or wedge under the slot end of the resonator such that the slots slope downwards in the propagation direction of the incident microwaves. Other angular deviations may also be possible.

FIGS. 8g to 8j show arrangements comprising two of the multi-slot resonators of FIG. 8d. By combining multiple resonators in this way various arrangements can be provided to offer improved I-V characteristics for generation and/or maintenance of ignition. In these arrangements the resonators are both located on the electrode (anode or cathode). In FIG. 8g the resonators are opposing each other and with baffles. That is they are arranged collinear with the slots facing each other but spaced apart. The direction of incidence of the microwave radiation is again from the right in the arrangement shown. Baffles are placed either side of the first resonator, that is, the resonator closest to the direction of incidence. FIG. 8h shows a similar arrangement as FIG. 8g but with one of the resonators offset in the vertical direction in relation to the other. Here the second resonator, that is the resonator furthest from the direction of incidence is offset vertically upwards from the electrode. In this arrangement the ends of one of the resonators face the slots of the other resonator.

In FIGS. 8i and 8j two resonators are shown forming angled pairs. In these cases they are angularly offset from each other. In FIG. 8i the slots of the resonators face or point towards the direction of incidence of the microwave radiation, which is again from the right in the figure. One of the resonators is aligned parallel to the direction of incidence and the other is offset by an angle such as 10-30 degrees or preferably around 15 degrees. The open jaws of the slots are the closest together parts of the resonators. FIG. 8i provides example dimensions in mm of the arrangement shown.

The arrangement of FIG. 8j is similar to the arrangement of FIG. 8g but without baffles and with the first resonator, that is the one closest to the direction of incidence, being offset by an angle to the incidence direction. This arrangement may be described as having the resonators opposing and angled. The jaws of the slots are again facing each other and the open ends of the jaws of the first resonator being approximately in line with the incidence direction and second resonator. The offset angle may be around 20-30 degrees to the incidence direction. FIG. 8j provides example dimensions in mm of the arrangement shown.

FIG. 8k shows three resonators having similar dimensions to those of the preceding figures but formed of wire, such as copper wire, instead of being machined from bulk material. These wire resonators may be used in any of the configurations described above in FIGS. 8d to 8j. In the arrangement of FIG. 8k the three resonators are arranged in a Y-configuration. The Y is aligned with the base or stick of the Y aligned parallel to the direction of incidence of the microwave, and similar to FIG. 8j the resonators closest to the incidence direction are angled to this direction. The arrangement may be considered to include a mirroring of the arrangement of FIG. 8j.

As shown in FIGS. 8g-8k there are various ways of arranging the multiple resonators. The figures show one of the resonators facing directly towards the microwave source. It is preferred that at least one of the resonators is at least partially facing the direction of the microwave source, that is, at least one resonator may be angled to, or directly facing towards the microwave source.

The use of multiple resonators can reduce the microwave power required for ignition and can also stabilise the plasma. Improved I-V performance not only means less microwave power is required for ignition but also that higher discharge powers can be achieved more readily.

### Detailed Photoreactor System

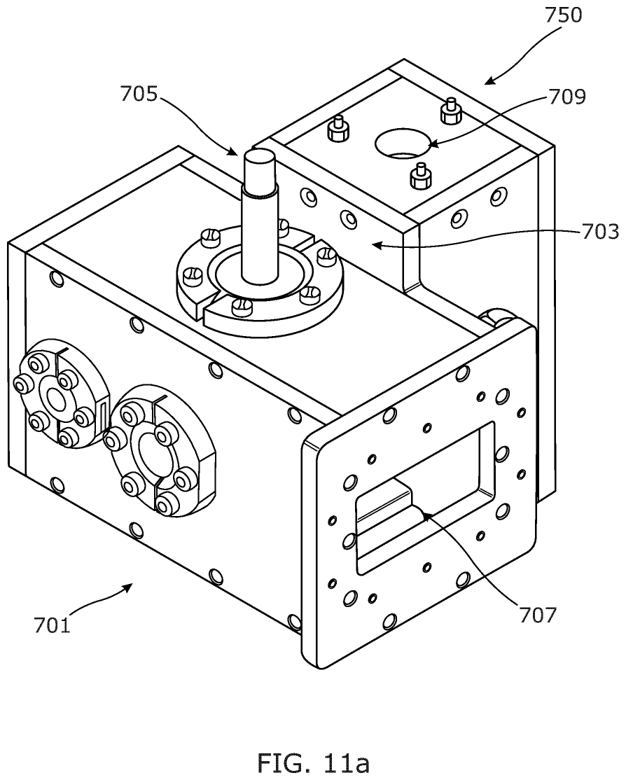

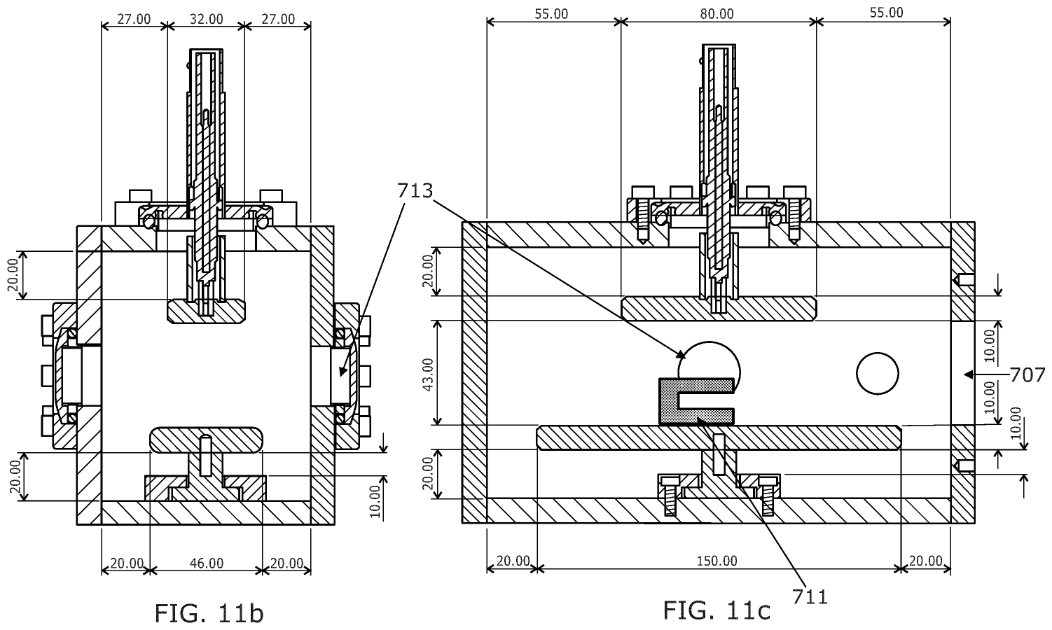

FIG. 11a is a perspective diagram showing a plasma chamber 701, similar to the one 700 in FIG. 7, coupled to a photoreactor 750. Not shown in the figure is a microwave barrier that stops microwaves in the chamber entering the photoreactor. The chamber 701 differs from that shown in FIG. 7 in that one side of the chamber is fitted with a flange plate 703 for connection of the chamber to the photoreactor. Alternatively, if the chamber is formed of a hollowed solid block, as described in embodiments relating to FIG. 7, the flange plate may be integrally formed as flanges to the block. The chamber 701 is fitted with two electrodes across which a voltage is generated to provide the electric field in the chamber. The electrodes connect to electrode plates in the chamber. The electrode plates are similar to the first and second electrodes 420 and 430 shown in FIG. 4. The top electrode 705 is insulated from the walls of the chamber. Another electrode is provided at the bottom of the chamber (not shown in FIG. 11a). This is also similar to the arrangement of FIG. 4. The bottom electrode may also be insulated from the chamber walls. FIGS. 11b and 11c shows cross-sections through the chamber 701 such that the electrodes can be seen. In the embodiment shown the bottom plate is not insulated from the walls of the chamber and is preferably grounded along with the walls of the chamber. The top plate is connected to the high voltage. The insulated connection is via a high voltage feedthrough. FIGS. 11a to 11c show an embodiment of the chamber and photoreactor. The dimensions provided here are exemplary and other dimensions are possible. The top and bottom plate electrodes are parallel and positioned 43 mm apart, in line with the top and bottom of the waveguide aperture and parallel to the walls. Both electrode plates are 10 mm thick. The top plate is 32 mm wide and 80 mm long, and the bottom plate is 46 mm wide and 150 mm long. The resonator is placed or fixed on the bottom electrode plate as shown in FIG. 11c, in line with FIG. 4. Other dimensions may be used, such as for different microwave frequencies, but it is preferable if the top and bottom plate electrodes are parallel and in line with the top and bottom of the waveguide aperture and parallel to the walls.

To ascertain spacings between electrodes, walls and resonator, to avoid arcing in unwanted positions, a spark gap breakdown test was performed with xenon. This showed that xenon has a breakdown of 3 kV/mm so for a 20 kV potential difference a 7 mm gap should be appropriate. In test arrangements the chamber may be purged with argon which has a breakdown of 0.83 kV/mm or 24 mm for 20 kV. Hence, in case of contamination with argon a conservative gap of 20 mm to avoid sparking was used. This was set as the minimum distance between the top plate and the chamber top and walls and also the minimum distance from the top of the resonator 711 to the top plate. The resonator is placed directly on the bottom (grounded) plate.

The photoreactor comprise a tube 709 which passes through hole and is shown arranged vertically in the embodiment of FIG. 11a. The tube should be as transparent as possible to the desired wavelength. For xenon excimer the wavelength is 172 nm and a high purity synthetic quartz tube may be used. Other options may instead be used and provide better transmission at 172 nm such as Hereaus Heralux® plus. The latter material tube transmits approximately 85% of incident 172 nm VUV for a 2 mm thickness. In our embodiment a 1 mm thick tube was used so providing improved transmission. Transmission at other wavelengths will depend on the precise material characteristics but for the material mentioned here higher wavelength UV will be transmitted more effectively. In general below 150 nm the transmittance of many quartz based glasses becomes low so other materials are required to be used. This means that the preferred wavelengths of interest are 150 or 160 nm and above. Other gases than xenon may be used such as the other noble gases, for example, argon.

The chamber is closed to prevent loss of xenon gas (or other gas). Window 713 allows VUV emitted from the plasma to be transmitted to the photoreactor and tube. Although the window is shown as relatively small in FIGS. 11b and 11c, larger windows are preferable. If the photoreactor is sealed, the window 713 may be an aperture such that the photoreactor, excluding the tube, is also filled with the relevant gas such as xenon.

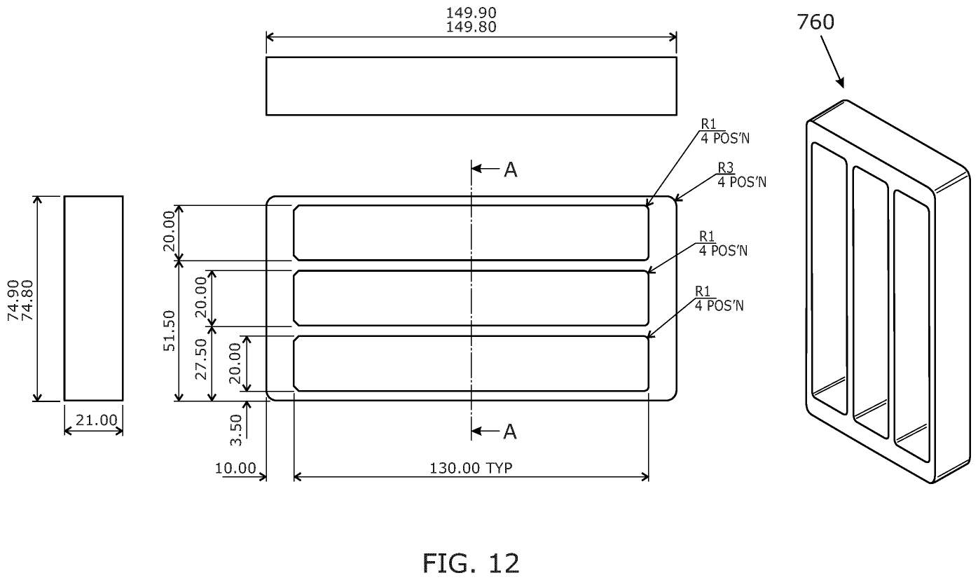

Also between the plasma chamber 701 and the photoreactor 750 is a microwave barrier. Microwaves at 2.45 GHz, such as mentioned earlier, are readily absorbed by water. Microwaves from the chamber that pass into the photoreactor could cause heating and boiling of water being treated as it passes through the photoreactor tube. To prevent escape of the microwaves a microwave barrier is used. A microwave barrier 760 is shown in FIG. 12. The microwave barrier should significantly reduce microwave transmission but allow as much VUV as possible to pass. To achieve this a microwave barrier was developed to attenuate microwaves while covering as little area as possible to maximise the VUV reaching the photoreactor tube. The design of the barrier will now be described.

The dispersion relation for TE mode in a rectangular waveguide provides that for 2.45 GHz microwaves to not be able to be transmitted and to die away evanescently, the gaps in the barrier in the TE direction should be about 6.1 cm or less. For such an evanescent mode and using the equation:

[symbol]

=1/(π¢[(n²/L²_{y})−(4f²/c²)]

where f=2.45 GHz, n=1, and setting a width Ly=20 mm, means that the slot length, [symbol] , for one e-folding (i.e. reduction by a factor of 1/e) is 7 mm. For three e-foldings (reduction by a factor of 1/e³), the depth required would be 21 mm. Based upon this, the power bleeding through the barrier should not exceed 5 W when 2000 W of power is supplied.

FIGS. 11a to 11c show how top electrode 705 connects to the upper plate electrode plate in the plasma chamber 701 via a feedthrough through the roof of the plasma chamber. The upper electrode plate (corresponding to 430′ in FIG. 4) is exposed to the incoming microwave radiation in the plasma chamber. This exposure to microwave radiation means that it is possible that a substantial amount of the microwave power may be picked up by the upper plate electrode. The high voltage connection to the upper electrode may take the form of a co-axial transmission line, which will very effectively transfer microwave power out of the chamber. The microwave power may travel along the transmission line and be transferred out of the plasma chamber, for example, to the environment or to the HV DC power supply.

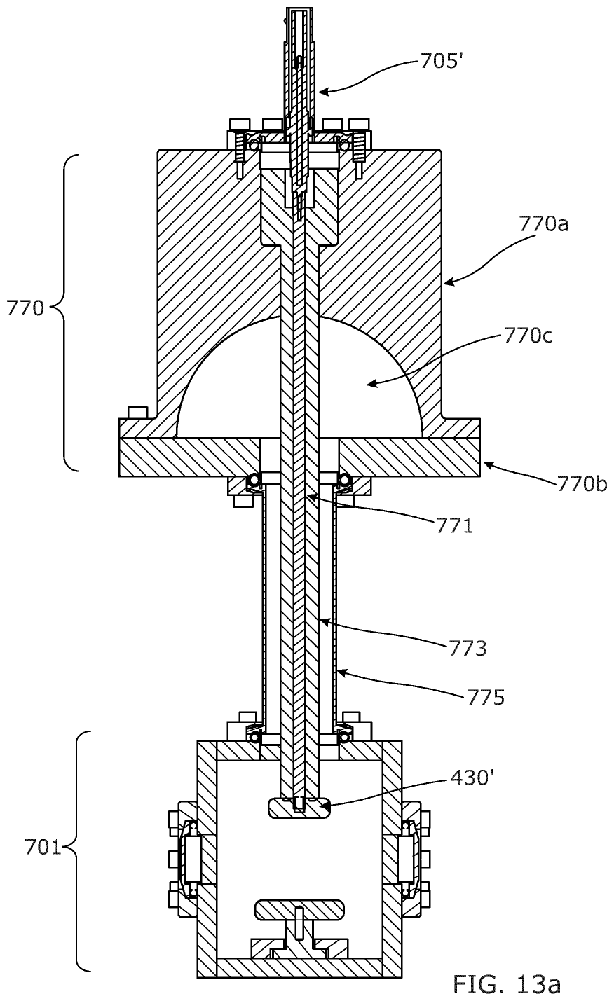

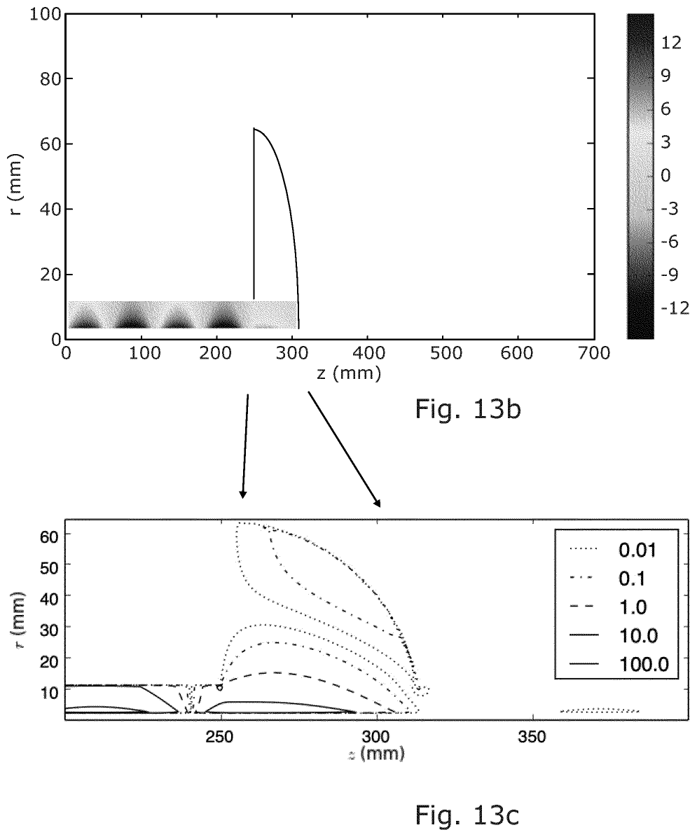

This transfer of microwave power from the plasma chamber introduces both efficiency and safety issues. For example, it may cause damage to the HV DC power supply. To address this a means of preventing, or reducing substantially, microwave power transferred out of the plasma chamber is provided. This comprises a passive microwave reflector and an embodiment is shown in FIG. 13a. FIG. 13a shows a modified feedthrough and supply line to the upper plate electrode, as compared to FIGS. 11a to 11c, so as to incorporate the passive microwave reflector. Instead of the electrode of the feedthrough connecting directly to the upper plate electrode, there is provided a co-axial section that leads from the upper electrode plate 430′, through the reflector 770, and terminating at a feedthrough electrode 705′ for connection to the HV DC supply. The feedthrough electrode 705′ is similar to the electrode 705 of FIG. 11a and upper plate electrode is similar to anode 430 of FIG. 4a. The passive microwave reflector 770 comprises hemispherical cavity 770c formed in reflector body 770a. The hemispherical cavity 770c is closed by reflector base plate 770b. The hemispherical cavity 770c faces the plasma chamber 701. The cavity contains any of air, the same gaseous species as the plasma chamber or a vacuum. A conductor 771, which may be a rod, connects to the upper plate electrode 430′ and is surrounded by insulator 773 which may be made of PEEK. The conductor, surrounded by the insulator, extends from the upper plate electrode, out of the plasma chamber, and through the hemispherical cavity 770c to feedthrough electrode 705′. The conductor 771 passes through the centre or origin of the hemispherical cavity. The passive microwave reflector 770 may be spaced from the plasma chamber 701. In such a case the conductor and surrounding insulator may be enclosed in a pipe 775, such as KF-pipe. The pipe, reflector body and reflector base plate are made of conducting material such as stainless steel.

The conductor-insulator (771-773) arrangement may be considered to form a transmission line along which the microwaves propagate. The hemispherical cavity 770c breaks the forward-backward symmetry along the transmission line and functions by supporting a resonant cavity mode. The resonant cavity mode might be termed a “spherical-conical” mode. FIGS. 13b and 13c are plots of electric field along the conductor through the hemispherical cavity 770c. In these figures the abscissa is distance, z, along the conductor, and the ordinate is the radial distance, r, from the centre of the conductor. The contours or depth of greyscale in the figures represent the magnitude of the electric field (in arbitrary units). The “spherical-conical” mode has a radial dependence where the radius is a spherical radius (as opposed to a cylindrical radius) from the hemisphere's origin. This means that there is a dependence along the axis of the conductor. Thus, the microwave power available to leave the cavity reduces along the rod in the direction away from the origin of the hemisphere towards the hemispherical cavity surface. If we assume that all the incoming power feeds the dominant cavity mode, namely the spherical conical mode, the power is reduced by a factor of 1/r² at the exit port of the hemisphere. Thus, for the microwave frequencies of interest, namely 2.45 GHz, for a hemisphere with a radius of 6 cm we can estimate that the reflector will reflect about 97% of the incoming power. The plots of FIGS. 13b and 13c have been generated using FDTD modelling. FIG. 13b shows that for z from 0 to 250 mm, which is along the conductor 771, the magnitude of the electric field varies periodically. At around 250 mm to 310 mm is the hemisphere and the electric field can be seen to continue its periodicity but also reduces significantly in magnitude. In FIG. 13b the dotted line has been added to show the location of the hemisphere. FIG. 13c is a contour plot in the region of the hemisphere. The contours also show the reducing magnitude of the electric field on axis in the hemisphere. The electric field is of low magnitude towards the surface of the hemisphere at all z. FDTD modelling shows that in excess of 99% of the incoming power to the reflector is reflected.

Although the reflector has been described based on a hemisphere shape, other shapes are also possible, which for example form a bowl, such as a parabola. The reflector has also been described with regard to the upper electrode in the plasma chamber. In the embodiments described herein the upper electrode plate is the HV anode and the lower electrode plate is the HV cathode. A reflector may be provided for the anode, the cathode, or both the anode and cathode. We describe that the cathode may be connected to the chamber walls. In such a case, the need for a reflector on the cathode supply may be reduced. Nevertheless, it is possible to arrange reflector on the cathode supply.

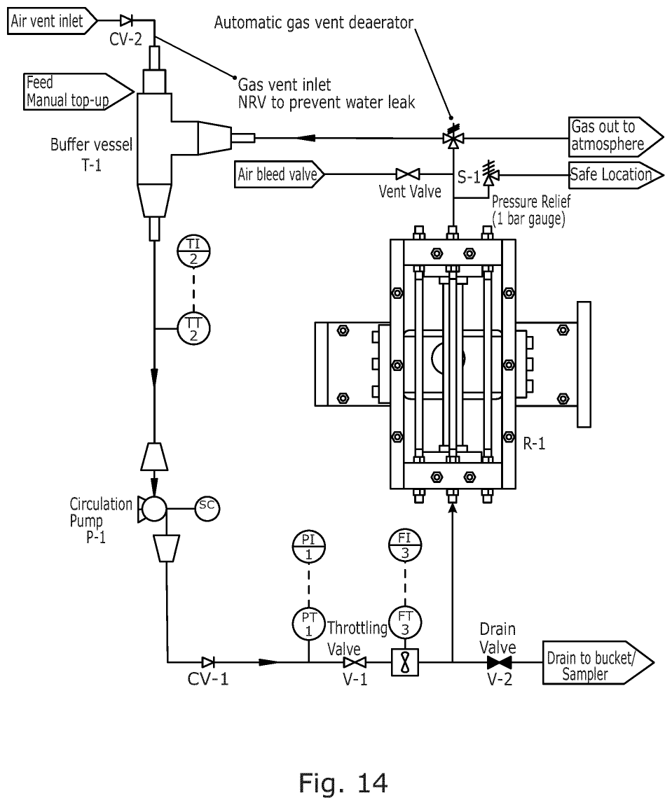

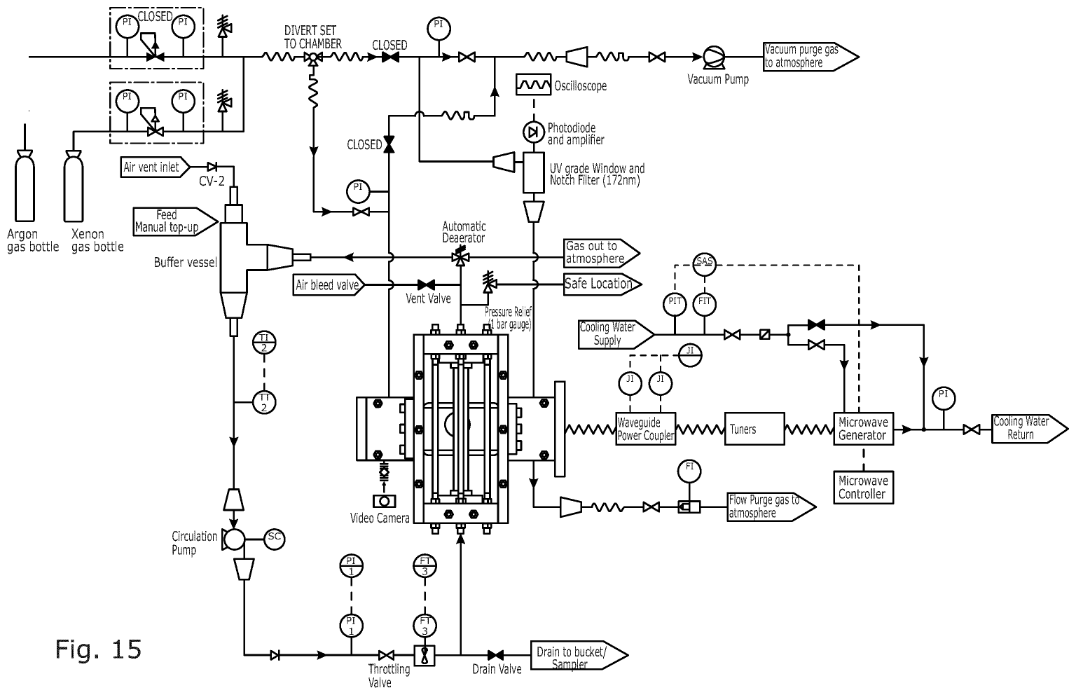

Having described the detailed embodiment of photoreactor we now describe in detail an embodiment of the photoreactor system. FIGS. 14 and 15 are process flow diagrams of recycle photoreactor systems comprising the chamber and photoreactor discussed above. FIG. 14 is directed to the core process flow, whereas FIG. 15 includes ancillary processes. The core process flow is based on the arrangement of FIG. 1. The photoreactor and plasma chamber can be seen at the centre of FIG. 14 corresponding to the photoreactor 110 and UV/UV source 120 in FIG. 1. A circulation pump is also included in FIG. 14 corresponding to pump 130 in FIG. 1. Drain valve for draining the charge or sample is shown in FIG. 14 corresponding to items 150 and 152 in FIG. 1, and vent valve for venting gas bubbles corresponding to 160 and 162 can also be seen. Lastly, feed and buffer vessel corresponding to 170 and 172 can also be seen in FIG. 14.

In FIG. 14 the buffer vessel and feed corresponding to 170, 172 may have a manual top-up or automated top-up. A manual top-up is indicated in the figure. A continuous flow system would include an automatic feed input and product output, instead of a manual top-up. In FIG. 14 the buffer vessel or feed also has an air vent inlet with a non-return valve to prevent water or charge leaking out. Temperature monitoring is performed on the flow circuit after the buffer vessel. The next item in the flow circuit in FIG. 14 is the circulation pump. A further non-return valve is provided after the pump to prevent charge from being sucked back into the pump. A throttling valve is used to maintain a constant flow rate. Temperature and flow are monitored at the input to the photoreactor. At the output of the photoreactor an automatic gas vent deaerator is fitted to allow air out of the system.

FIG. 15 adds the microwave components as well as xenon and argon gas fill/purge components. We will not describe in detail the gas fill and purge components because they are largely conventional processing details, with the addition of a photodiode and amplifier for monitoring VUV/UV emission and control thereof. Furthermore, although the system of FIG. 15 shows fill/purge components the VUV emission sources according to the present invention will be filled with the required amount of xenon which will be contained within the lamp for the life of the lamp. Optionally, a refill valve may be provided if some of the gas is lost over extended use or time periods. The microwave components shown in FIG. 15 are similar to those of FIG. 6 and include a microwave generator, optional tuner for impedance matching, a waveguide coupler for power monitoring and a controller. Additionally, the microwave generator is cooled by water as shown in FIG. 15.

The person skilled in the art will readily appreciate that various modifications and alterations may be made to the above described emission source, resonator, photoreactor, and photoreactor system without departing from the scope of the appended claims. For example, different gases may be used to provide different emission wavelengths, different waste products may be treated by the emission, and different wavelengths of microwaves may be used. Correspondingly, different dimensions and materials may be used.

1. A vacuum ultraviolet (VUV) and/or ultraviolet (UV) emission source, the source comprising:
a microwave generator;
a chamber arranged to receive microwaves generated by the microwave generator, the chamber comprising:
a gas comprising species for forming excimers;
a resonator arranged to receive the microwaves in the chamber and generate a plasma;
a first electrode spaced apart from the resonator; and
a voltage source configured to generate an electric field between the resonator and the first electrode,
wherein, on application of the electric field, the electric field drives electrons and/or ions from the plasma to generate excimers and produce vacuum ultraviolet or ultraviolet emission.

2. The emission source of claim 1, wherein, on the application of the electric field, the electrons and/or ions are driven from the plasma towards the first electrode and they collide with the gas species to generate the excimers.

3. The emission source of claim 1, wherein the resonator is configured to generate the plasma at the resonator independently of the electric field.

4. The emission source of claim 1, wherein the voltage source is configured to generate a DC electric field.

5. The emission source of claim 1, wherein the resonator is configured to generate the plasma at an electron or ion source region at the resonator, and the electric field drives the ions or electrons from the plasma towards the first electrode through a drift region.

6. The emission source of claim 1, wherein the first electrode is an anode and the electric field drives electrons from the plasma towards the first electrode.

7. The emission source of claim 1, wherein at least part of the resonator extends into or across the straight-line path between the plasma and first electrode so as to spread the area across which the electrons or ions are driven towards the first electrode.

8. The emission source of claim 7, wherein the width of the at least part of the resonator extending into the straight-line path is larger than width of the plasma.

9. The emission source of claim 1, wherein the chamber comprises a waveguide with a short-circuit termination.

10. The emission source of claim 9, wherein the resonator comprises an initiation region where the plasma initiates, the resonator disposed with the initiation region at a position substantially an odd number of quarter-wavelengths from the short-circuit termination of the waveguide.

11. The emission source of claim 1, wherein the resonator comprises a planar structure configured to provide a planar region of electron injection to the gas.

12. The emission source of claim 1, wherein the resonator comprises an opening or mouth for receiving microwaves from the microwave generator, the mouth or opening extending into a slot or channel with an end termination.

13. The emission source of claim 12, wherein the resonator comprises an upper and lower jaw, each jaw having a planar region.

14. The emission source of claim 13, wherein at least one of the jaws has holes therethrough.

15. The emission source of claim 12, wherein the slot or channel has a length substantially equal to a quarter of the wavelength of the microwaves.

16. The emission source of claim 12, wherein the slot or channel has a length substantially equal to an odd number of quarter wavelengths of the microwaves.

17. The emission source of claim 13, wherein each of the resonator jaws comprises a planar region, the upper and lower jaws being parallel and spaced apart.

18. The emission source of claim 17, wherein the resonator jaws are formed by a plate or plate region, or formed by bulk material machined to form the parallel planar regions.

19. The emission source of claim 17, wherein the planar regions of the resonator jaws are parallel to the plane of the anode and/or a planar cathode.

20. The emission source of claim 13, wherein the resonator jaws are formed of plates or plate regions, and the plates or plate regions are co-planar and arranged transverse to the plane of the anode and/or a planar cathode.

21. The emission source of claim 18, wherein one of the planar regions comprises a pin extending into the slot or channel from one of the planar regions.

22. The emission source of claim 21, wherein the resonator comprises multiple slots.

23. The emission source of claim 1, wherein the resonator is U-shaped.

24. The emission source of claim 1, comprising a plurality of resonators.

25. The emission source of claim 1, further comprising a waveguide configured to guide the microwaves from the microwave generator to the chamber.

26. The emission source of claim 1, wherein the chamber comprises one or more gas ports for fill and/or evacuation of the gas.

27. The emission source claim 1, wherein the chamber comprises metal walls with a microwave window for receiving the microwaves and an optical window for exit of generated VUV or UV.

28. The emission source of claim 27, further comprising a microwave barrier to block or reduce exit of microwaves from the chamber but allowing VUV and/or UV to pass through the microwave barrier.

29. The emission source of claim 27, wherein the microwave barrier is arranged across the optical window.

30. The emission source of claim 1, wherein the first electrode is an anode and the chamber further comprises a cathode.

31. The emission source of claim 30, wherein the resonator or resonators are arranged in contact with one of the anode or cathode, and the voltage source generating an electric field between the anode and the cathode.

32. The emission source of claim 31, wherein the resonator is between the anode and cathode, and the resonator or resonators are in contact with a face of one of the anode or cathode and is facing the other of the anode and cathode.

33. The emission source of claim 30, wherein the anode and cathode each comprise a planar surface, the planar surfaces spaced apart and substantially parallel.

34. The emission source of claim 30, wherein the anode and cathode comprise plates spaced apart from walls of the chamber.

35. The emission source of claim 30, wherein at least one of the anode and cathode is electrically isolated/insulated from walls of the chamber.

36. The emission source of claim 35, wherein the first electrode or a second electrode is connected to a conductor extending from the chamber and for electrical connection to the voltage source, the emission source further comprising a microwave reflector disposed axially to the conductor for reflecting microwaves back to the chamber.

37. The emission source of claim 36, wherein the microwave reflector comprises an enclosed bowl shape cavity facing towards the chamber.

38. The emission source of claim 37, wherein the bowl shape cavity is a hemisphere.

39. The emission source of claim 38, wherein the conductor extends through the origin of the hemisphere and through or towards a feedthrough for connection to the voltage source.

40. The emission source of claim 1, wherein the VUV or UV light generated is predominantly at 172 nm.

41. The emission source of claim 1, wherein the gas comprising species for generating excimers is at least one of xenon gas and argon gas.

42. The emission source of claim 1, further comprising a controller arranged to:
control the microwave source to generate a first power level of microwaves to initiate the plasma;
control the microwave source or an attenuator to reduce the power level of microwaves incident in the chamber to a second level, lower than the first, to sustain the plasma; and
control the voltage source to turn on or increase the voltage so as to increase the electric field between the resonator and first electrode to drive the electrons or ions from the plasma to generate the excimers in the gas and produce the vacuum ultraviolet or ultraviolet emission.

43. The emission source of claim 1, wherein the microwave source is configured to provide microwaves at a frequency in air of 2.45 GHz.

44. The emission source of claim 1, wherein the microwave source provides a maximum power of 2 kW of microwaves.

45. The emission source of claim 1, wherein the voltage source is an HV source configured to supply a voltage of the order of kV or tens of kV between the resonator and first electrode, or between the first electrode and a second electrode.

46. A method of generating vacuum ultraviolet (VUV) or ultraviolet (UV) emission, comprising:
providing in a chamber a gas comprising species for generating excimers;
supplying microwaves at a first power level to a chamber comprising a resonator to generate a plasma at the resonator;
reducing or attenuating the power level of the microwaves supplied to the chamber to a second level, lower than the first level, to sustain the plasma;
supplying a high voltage to generate an electric field in the chamber to drive electrons or ions from the plasma to generate excimers in the gas so as to produce the VUV or UV emission.

47. A photoreactor for receiving fluid for treatment, the photoreactor comprising:
the VUV or UV emission source of claim 1; and
a vessel or tube for receiving the fluid for treatment, the vessel or tube having one or more regions transparent to VUV and/or UV for receiving VUV or UV from the emission source.

48. The photoreactor of claim 47, further comprising a second chamber in which is disposed the vessel or tube.

49. The photoreactor of claim 48, further comprising a microwave barrier arranged between the chamber of the VUV or UV emission source and the second chamber to block or reduce microwaves from the VUV or UV emission source from entering the second chamber.

50. The photo reactor of claim 48, wherein the vessel or tube for receiving the fluid is a tube, and the second chamber is a metal walled box with holes through which each end of the tube extends.

51. A recycle photoreactor system, comprising the photoreactor of claim 47, and further comprising:
a flow circuit around which the fluid for treatment may flow into and out of the vessel or tube; and
a pump for circulating the fluid around the flow circuit and through the vessel or tube.

52. A continuous flow photoreactor system, comprising the photoreactor of claim 47, and further comprising:
a flow circuit or piping which feeds fluid for treatment to the vessel or tube and outputs the treated products; and
optionally, a pump for driving the fluid for treatment through the vessel or tube.

53. The recycle photoreactor system of claim 51, wherein the system is configured for receiving fluid for treatment which is a liquid, and the vessel or tube is substantially tubular and is arranged such that the flow direction of the fluid for treatment though the tube is in a direction substantially vertically upwards.

54. A method of treating a fluid, comprising:
flowing the fluid for treatment through a vessel or tube connected to a flow circuit or piping;
generating VUV or UV emission using the method of claim 46
directing the VUV or UV at the fluid flowing in the vessel or tube;
driving the fluid through the vessel or tube and flow circuit or piping; and
removing the treated fluid.

55. The method of claim 54, wherein the method is:
a batch process processing fluid to be treated in a recycle system having a flow circuit; or
a continuous flow process processing fluid to be treated in a continuous process.

56. The method of claim 54, wherein the fluid is a gas and the process remediates NOx, SOx and/or VOCs.

57. The method of claim 54, wherein the fluid is contaminated water and the process remediates organic compounds in the water.

58. The continuous flow photoreactor system of claim 52, wherein the system is configured for receiving fluid for treatment which is a liquid, and the vessel or tube is substantially tubular and is arranged such that the flow direction of the fluid for treatment though the tube is in a direction substantially vertically upwards.
